(19) United States
(12) Patent Application Publication
(10) Pub. No.: US 2025/0157476 A1
(43) Pub. Date: May 15, 2025

(54) AUDIO SIGNAL PROCESSING METHOD AND APPARATUS, STORAGE MEDIUM, AND COMPUTER PROGRAM PRODUCT

(71) Applicant: HUAWEI TECHNOLOGIES CO., LTD., Shenzhen (CN)

(72) Inventors: Zhuo Wang, Shenzhen (CN); Bin Feng, Shenzhen (CN); Chunhui Du, Shenzhen (CN); Fan Fan, Shenzhen (CN)

(73) Assignee: HUAWEI TECHNOLOGIES CO., LTD., Shenzhen (CN)

(21) Appl. No.: 19/026,327

(22) Filed: Jan. 16, 2025

Related U.S. Application Data
(63) Continuation of application No. PCT/CN2023/092053, filed on May 4, 2023.

(30) Foreign Application Priority Data
Jul. 27, 2022 (CN) 202210894324.9
Sep. 19, 2022 (CN) 202211139940.X

(51) Int. Cl. G10L 19/02

(52) U.S. Cl. CPC G10L 19/0204

(57) ABSTRACT

An audio signal processing method and apparatus, a storage medium, and a computer program product are provided. An optimal sub-band division manner is selected from a plurality of sub-band division manners based on a characteristic of an audio signal. In other words, the sub-band division manner has a signal adaptation characteristic, and can adapt to an encoding bit rate of the audio signal. Specifically, a total scale value corresponding to each sub-band division manner is determined based on spectral values of the audio signal in sub-bands obtained through division, a bandwidth of each sub-band, and the encoding bit rate of the audio signal, and an optimal target sub-band division manner is selected based on the total scale value, to obtain an optimal sub-band set. Subsequently, spectral envelope shaping is performed based on a scale factor of each sub-band in the optimal sub-band set, to improve coding effect and compression efficiency.

### CROSS-REFERENCE TO RELATED APPLICATIONS

This application is a continuation of International Application No. PCT/CN2023/092053, filed on May 4, 2023, which claims priority to Chinese Patent Application No. 202210894324.9, filed on Jul. 27, 2022 and Chinese Patent Application No. 202211139940.X, filed on Sep. 19, 2022. All of the aforementioned patent applications are hereby incorporated by reference in their entireties.

### TECHNICAL FIELD

This application relates to the audio encoding/decoding field, and in particular, to an audio signal processing method and apparatus, a storage medium, and a computer program product.

### BACKGROUND

As quality of life improves, people have increasing requirements on high-quality audio. To better transmit an audio signal on a limited bandwidth, data compression usually needs to be performed on the audio signal at an encoder side, to obtain a bitstream. Then, the bitstream is transmitted to a decoder side. The decoder side decodes the received bitstream, to reconstruct the audio signal. The reconstructed audio signal is used for playback. However, in a process of compressing the audio signal, sound quality of the audio signal may be affected. Therefore, how to improve compression efficiency of an audio signal while ensuring sound quality of the audio signal becomes a technical problem that urgently needs to be resolved.

### SUMMARY

This application provides an audio signal processing method and apparatus, a storage medium, and a computer program product, to improve coding effect and compression efficiency. The technical solutions are as follows.

According to a first aspect, an audio signal processing method is provided. The method includes:
separately performing sub-band division on an audio signal based on a plurality of sub-band division manners and cut-off sub-bands corresponding to the plurality of sub-band division manners, to obtain a plurality of candidate sub-band sets, where the plurality of candidate sub-band sets one-to-one correspond to the plurality of sub-band division manners, and each candidate sub-band set includes a plurality of sub-bands; determining a total scale value of each candidate sub-band set based on spectral values of the audio signal in the sub-bands included in the candidate sub-band set, an encoding bit rate of the audio signal, and sub-band bandwidths of the sub-bands included in the candidate sub-band set; and selecting, as a target sub-band set, one candidate sub-band set from the plurality of candidate sub-band sets based on the total scale value of each candidate sub-band set, where each sub-band included in the target sub-band set has a scale factor, and the scale factor is used to shape a spectral envelope of the audio signal.

In this application, an optimal sub-band division manner is selected from the plurality of sub-band division manners based on a characteristic of the audio signal. In other words, the sub-band division manner has a signal adaptation characteristic, and can adapt to the encoding bit rate of the audio signal, to improve an anti-interference capability. Specifically, the audio signal is divided separately based on the plurality of sub-band division manners, a total scale value corresponding to each sub-band division manner is determined based on spectral values of the audio signal in sub-bands obtained through division, a bandwidth of each sub-band, and the encoding bit rate of the audio signal, and an optimal target sub-band division manner is selected based on the total scale value, to obtain an optimal sub-band set. Subsequently, spectral envelope shaping is performed based on a scale factor of each sub-band in the optimal sub-band set, to improve coding effect and compression efficiency.

Optionally, the selecting, as a target sub-band set, one candidate sub-band set from the plurality of candidate sub-band sets based on the total scale value of each candidate sub-band set includes:
determining, as the target sub-band set, a candidate sub-band set with a smallest total scale value in the plurality of candidate sub-band sets.

Optionally, the determining a total scale value of each candidate sub-band set based on spectral values of the audio signal in the sub-bands included in the candidate sub-band set, an encoding bit rate of the audio signal, and sub-band bandwidths of the sub-bands included in the candidate sub-band set includes:
for a first candidate sub-band set in the plurality of candidate sub-band sets, determining, based on spectral values of the audio signal in sub-bands included in the first candidate sub-band set, a scale factor of each sub-band included in the first candidate sub-band set, where the first candidate sub-band set is any one of the plurality of candidate sub-band sets; and
determining a total scale value of the first candidate sub-band set based on the encoding bit rate of the audio signal, and the scale factor and a sub-band bandwidth of each sub-band included in the first candidate sub-band set.

Optionally, the determining, based on spectral values of the audio signal in sub-bands included in the first candidate sub-band set, a scale factor of each sub-band included in the first candidate sub-band set includes:
for a first sub-band included in the first candidate sub-band set, obtaining a maximum value in absolute values of all spectral values of the audio signal in the first sub-band, where the first sub-band is any sub-band in the first candidate sub-band set; and
determining a scale factor of the first sub-band based on the maximum value.

Optionally, the encoding bit rate of the audio signal is not less than a first bit rate threshold, and/or an energy concentration of the audio signal is greater than a concentration threshold.

The determining a total scale value of the first candidate sub-band set based on the encoding bit rate of the audio signal, and the scale factor and a sub-band bandwidth of each sub-band included in the first candidate sub-band set includes:
determining an energy smooth reference value based on the encoding bit rate of the audio signal and a second bit rate threshold;
determining, based on the energy smooth reference value, and the scale factor and the sub-band bandwidth of each sub-band included in the first candidate sub-band set, a total energy value of each sub-band included in the first candidate sub-band set; and
adding up the total energy values of the sub-bands included in the first candidate sub-band set, to obtain the total scale value of the first candidate sub-band set.

Optionally, the determining, based on the energy smooth reference value, and the scale factor and the sub-band bandwidth of each sub-band included in the first candidate sub-band set, a total energy value of each sub-band included in the first candidate sub-band set includes:
for the first sub-band included in the first candidate sub-band set, determining, as a reference scale value of the first sub-band, a larger value in the scale factor of the first sub-band and the energy smooth reference value, where the first sub-band is any sub-band in the first candidate sub-band set; and
determining, as a total energy value of the first sub-band, a product of the reference scale value of the first sub-band and a sub-band bandwidth of the first sub-band.

Optionally, the encoding bit rate of the audio signal is less than a first bit rate threshold, and an energy concentration of the audio signal is not greater than a concentration threshold.

The determining a total scale value of the first candidate sub-band set based on the encoding bit rate of the audio signal, and the scale factor and a sub-band bandwidth of each sub-band included in the first candidate sub-band set includes:
determining an energy smooth reference value based on the encoding bit rate of the audio signal and a second bit rate threshold;
determining, based on the energy smooth reference value and the scale factor of each sub-band included in the first candidate sub-band set, scale difference values of the sub-bands included in the first candidate sub-band set, where the scale difference value indicates a difference between a scale factor of a corresponding sub-band and a scale factor of an adjacent sub-band of the corresponding sub-band; and
determining the total scale value of the first candidate sub-band set based on the scale difference values of the sub-bands included in the first candidate sub-band set and the sub-band bandwidth of each sub-band.

Optionally, the determining, based on the energy smooth reference value and the scale factor of each sub-band included in the first candidate sub-band set, scale difference values of the sub-bands included in the first candidate sub-band set includes:
for the first sub-band included in the first candidate sub-band set, determining a first smooth value, a second smooth value, and a third smooth value of the first sub-band based on the energy smooth reference value, the scale factor of the first sub-band, and a scale factor of an adjacent sub-band of the first sub-band, where the first sub-band is any sub-band in the first candidate sub-band set; and
determining a scale difference value of the first sub-band based on the first smooth value, the second smooth value, and the third smooth value of the first sub-band.

Optionally, the determining a first smooth value, a second smooth value, and a third smooth value of the first sub-band based on the energy smooth reference value, the scale factor of the first sub-band, and a scale factor of an adjacent sub-band of the first sub-band includes:
if the first sub-band is an initial sub-band in the first candidate sub-band set, determining, as the first smooth value of the first sub-band, a larger value in the scale factor of the first sub-band and the energy smooth reference value; or if the first sub-band is not an initial sub-band in the first candidate sub-band set, determining, as the first smooth value of the first sub-band, a larger value in a scale factor of a previous sub-band adjacent to the first sub-band and the energy smooth reference value;
determining, as the second smooth value of the first sub-band, a larger value in the scale factor of the first sub-band and the energy smooth reference value; and
if the first sub-band is a last sub-band in the first candidate sub-band set, determining, as the third smooth value of the first sub-band, a larger value in the scale factor of the first sub-band and the energy smooth reference value; or if the first sub-band is not a last sub-band in the first candidate sub-band set, determining, as the third smooth value of the first sub-band, a larger value in a scale factor of a next sub-band adjacent to the first sub-band and the energy smooth reference value.

Optionally, the determining a scale difference value of the first sub-band based on the first smooth value, the second smooth value, and the third smooth value of the first sub-band includes:
for the first sub-band included in the first candidate sub-band set, determining a first difference value and a second difference value of the first sub-band, where the first difference value is an absolute value of a difference value between the first smooth value and the second smooth value of the first sub-band, the second difference value is an absolute value of a difference value between the second smooth value and the third smooth value of the first sub-band, and the first sub-band is any sub-band in the first candidate sub-band set; and
determining the scale difference value of the first sub-band based on the first difference value and the second difference value of the first sub-band.

Optionally, the determining the total scale value of the first candidate sub-band set based on the scale difference values of the sub-bands included in the first candidate sub-band set and the sub-band bandwidth of each sub-band includes:
determining, based on a number of sub-bands included in the first candidate sub-band set and the sub-band bandwidth of each sub-band, a smooth weighting coefficient of each sub-band included in the first candidate sub-band set;
adding up the smooth weighting coefficients of the sub-bands included in the first candidate sub-band set, to obtain a total smooth weighting coefficient of the first candidate sub-band set;
multiplying the scale difference values of the sub-bands included in the first candidate sub-band set by the smooth weighting coefficients, to obtain weighted scale difference values of the sub-bands included in the first candidate sub-band set;
adding up the weighted scale difference values of the sub-bands included in the first candidate sub-band set, to obtain a summation scale value of the first candidate sub-band set; and
dividing the summation scale value by the total smooth weighting coefficient of the first candidate sub-band set, to obtain the total scale value of the first candidate sub-band set.

Optionally, the method further includes:
if the encoding bit rate of the audio signal is less than the first bit rate threshold, performing bandwidth detection on a spectrum of the audio signal, to obtain a cut-off frequency of the audio signal; and
determining, based on the cut-off frequency, the cut-off sub-bands respectively corresponding to the plurality of sub-band division manners.

Optionally, the method further includes:
if the encoding bit rate of the audio signal is not less than the first bit rate threshold, determining, as a cut-off sub-band corresponding to each sub-band division manner, a last sub-band indicated by each of the plurality of sub-band division manners. Optionally, the method further includes:
performing feature analysis on the spectrum of the audio signal, to obtain a feature analysis result; and
determining the plurality of sub-band division manners from a plurality of candidate sub-band division manners based on the feature analysis result and the encoding bit rate of the audio signal.

Optionally, the feature analysis result includes a subjective signal flag or an objective signal flag, the subjective signal flag indicates that the energy concentration of the audio signal is not greater than the concentration threshold, and the objective signal flag indicates that the energy concentration of the audio signal is greater than the concentration threshold.

Optionally, a frame length of the audio signal is 10 milliseconds, and a sampling rate is 88.2 kilohertz or 96 kilohertz; or a frame length of the audio signal is 5 milliseconds, and a sampling rate is 88.2 kilohertz or 96 kilohertz; or a frame length of the audio signal is 10 milliseconds, and a sampling rate is 44.1 kilohertz or 48 kilohertz.

The determining the plurality of sub-band division manners from a plurality of candidate sub-band division manners based on the feature analysis result and the encoding bit rate of the audio signal includes:
if the encoding bit rate of the audio signal is less than the first bit rate threshold, and the feature analysis result includes the subjective signal flag, determining, as the plurality of sub-band division manners, a first group of sub-band division manners in the plurality of candidate sub-band division manners.

The first group of sub-band division manners are as follows:
{
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 3, 5, 7, 9, 12, 15, 18, 22, 26, 30, 35, 41, 48, 56, 65, 74, 84, 94, 106, 118, 134, 150, 166, 184, 202, 220, 240, 260, 280, 480},
{0, 1, 2, 3, 4, 5, 7, 9, 11, 14, 17, 21, 25, 29, 34, 40, 46, 52, 60, 68, 76, 86, 98, 110, 126, 144, 162, 180, 200, 224, 250, 280, 480},
{0, 2, 4, 6, 8, 12, 16, 21, 26, 31, 36, 41, 46, 51, 56, 61, 66, 71, 77, 83, 89, 95, 103, 111, 121, 131, 147, 163, 179, 203, 240, 280, 480},
{0, 1, 2, 3, 5, 7, 9, 12, 15, 19, 23, 27, 32, 37, 43, 49, 57, 66, 76, 86, 98, 110, 125, 140, 158, 176, 194, 216, 238, 264, 290, 320, 480},
{0, 1, 2, 3, 5, 7, 10, 13, 17, 21, 25, 30, 35, 41, 47, 54, 62, 70, 80, 90, 102, 114, 130, 146, 162, 180, 198, 218, 240, 264, 290, 320, 480},
{0, 1, 2, 4, 6, 8, 11, 14, 18, 22, 26, 30, 36, 42, 50, 58, 66, 76, 88, 100, 112, 128, 144, 160, 182, 204, 226, 256, 286, 316, 352, 400, 480},
{0, 1, 2, 4, 6, 8, 11, 14, 18, 22, 26, 30, 36, 42, 50, 58, 68, 78, 90, 102, 116, 132, 148, 166, 186, 208, 234, 262, 292, 324, 360, 400, 480}
}.

Optionally, a frame length of the audio signal is 10 milliseconds, and a sampling rate is 88.2 kilohertz or 96 kilohertz; or a frame length of the audio signal is 5 milliseconds, and a sampling rate is 88.2 kilohertz or 96 kilohertz; or a frame length of the audio signal is 10 milliseconds, and a sampling rate is 44.1 kilohertz or 48 kilohertz.

The determining the plurality of sub-band division manners from a plurality of candidate sub-band division manners based on the feature analysis result and the encoding bit rate of the audio signal includes:
if the encoding bit rate of the audio signal is not less than the first bit rate threshold, and/or the feature analysis result includes the objective signal flag, determining, as the plurality of sub-band division manners, a second group of sub-band division manners in the plurality of candidate sub-band division manners.

The second group of sub-band division manners are as follows:
{
{0, 1, 2, 3, 4, 5, 6, 7, 8, 10, 12, 14, 16, 19, 22, 26, 30, 35, 40, 45, 50, 57, 64, 73, 82, 92, 102, 112, 124, 136, 148, 160, 480},
{0, 1, 2, 3, 4, 5, 7, 9, 11, 13, 15, 18, 21, 24, 28, 33, 38, 44, 50, 57, 64, 73, 82, 93, 104, 116, 128, 140, 155, 170, 185, 200, 480},
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 4, 6, 10, 14, 18, 22, 26, 30, 34, 42, 50, 58, 66, 74, 84, 96, 108, 120, 136, 152, 168, 192, 216, 240, 272, 304, 336, 376, 424, 480},
{0, 1, 2, 4, 6, 10, 14, 18, 26, 34, 42, 50, 62, 74, 86, 98, 112, 128, 144, 160, 176, 196, 216, 236, 256, 280, 304, 328, 352, 384, 416, 448, 480},
{0, 80, 92, 104, 112, 120, 128, 136, 144, 148, 152, 156, 160, 164, 168, 172, 176, 180, 184, 188, 192, 196, 200, 208, 216, 224, 232, 240, 248, 256, 268, 280, 480},
{0, 200, 212, 224, 232, 240, 248, 256, 264, 268, 272, 276, 280, 284, 288, 292, 296, 300, 304, 308, 312, 316, 320, 328, 336, 344, 352, 360, 368, 376, 388, 400, 480},
{0, 320, 332, 344, 356, 364, 372, 380, 384, 388, 392, 396, 400, 404, 408, 412, 416, 420, 424, 428, 432, 436, 440, 444, 448, 452, 456, 460, 464, 468, 472, 476, 480}}
}.

Optionally, a frame length of the audio signal is 5 milliseconds, and a sampling rate is 44.1 kilohertz or 48 kilohertz.

The determining the plurality of sub-band division manners from a plurality of candidate sub-band division manners based on the feature analysis result and the encoding bit rate of the audio signal includes:
if the encoding bit rate of the audio signal is less than the first bit rate threshold, and the feature analysis result includes the subjective signal flag, determining, as the plurality of sub-band division manners, a third group of sub-band division manners in the plurality of candidate sub-band division manners.

The third group of sub-band division manners are as follows:
{
{0, 1, 2, 3, 4, 5, 6, 7, 8, 9, 10, 12, 14, 16, 19, 22, 26, 30, 35, 39, 44, 50, 56, 63, 71, 80, 89, 98, 108, 119, 129, 140, 240},
{0, 1, 2, 3, 4, 5, 6, 7, 8, 9, 11, 13, 15, 17, 20, 24, 28, 32, 37, 42, 47, 53, 59, 67, 75, 83, 92, 101, 110, 120, 130, 140, 240},
{0, 1, 2, 3, 4, 5, 6, 7, 8, 9, 10, 11, 12, 14, 17, 20, 23, 26, 30, 34, 38, 43, 49, 55, 63, 72, 81, 90, 100, 112, 125, 140, 240},
{0, 1, 2, 3, 4, 6, 8, 10, 13, 15, 18, 20, 23, 25, 28, 30, 33, 35, 38, 41, 44, 47, 51, 55, 60, 65, 73, 81, 89, 101, 120, 140, 240},
{0, 1, 2, 3, 4, 5, 6, 7, 9, 11, 13, 14, 16, 18, 21, 24, 28, 33, 38, 43, 49, 55, 62, 70, 79, 88, 97, 108, 119, 132, 145, 160, 240},
{0, 1, 2, 3, 4, 5, 6, 7, 8, 10, 12, 14, 17, 20, 23, 27, 31, 35, 40, 45, 51, 57, 65, 73, 81, 90, 99, 109, 120, 132, 145, 160, 240},
{0, 1, 2, 3, 4, 5, 6, 7, 9, 11, 13, 15, 18, 21, 25, 29, 33, 38, 44, 50, 56, 64, 72, 80, 91, 102, 113, 128, 143, 158, 176, 200, 240},
{0, 1, 2, 3, 4, 5, 6, 7, 9, 11, 13, 15, 18, 21, 25, 29, 34, 39, 45, 51, 58, 66, 74, 83, 93, 104, 117, 131, 146, 162, 180, 200, 240}
}.

Optionally, a frame length of the audio signal is 5 milliseconds, and a sampling rate is 44.1 kilohertz or 48 kilohertz.

The determining the plurality of sub-band division manners from a plurality of candidate sub-band division manners based on the feature analysis result and the encoding bit rate of the audio signal includes:
if the encoding bit rate of the audio signal is not less than the first bit rate threshold, and/or the feature analysis result includes the objective signal flag, determining, as the plurality of sub-band division manners, a fourth group of sub-band division manners in the plurality of candidate sub-band division manners.

The fourth group of sub-band division manners are as follows:
{
{0, 1, 2, 3, 4, 5, 6, 7, 8, 9, 10, 11, 12, 13, 14, 15, 16, 17, 18, 19, 20, 21, 22, 23, 24, 26, 28, 30, 32, 34, 37, 40, 120},
{0, 1, 2, 3, 4, 5, 6, 7, 8, 9, 10, 11, 12, 13, 14, 15, 16, 18, 20, 22, 24, 26, 28, 30, 32, 34, 36, 38, 41, 44, 47, 50, 120},
{0, 1, 2, 3, 4, 5, 6, 7, 8, 9, 10, 11, 12, 14, 16, 18, 20, 22, 24, 26, 28, 31, 34, 37, 40, 44, 48, 52, 56, 60, 65, 70, 120},
{0, 1, 2, 3, 4, 5, 6, 7, 8, 9, 10, 11, 12, 13, 15, 17, 19, 21, 24, 27, 30, 34, 38, 42, 48, 54, 60, 68, 76, 84, 94, 106, 120},
{0, 1, 2, 3, 4, 5, 6, 7, 8, 10, 12, 14, 16, 19, 22, 25, 28, 32, 36, 40, 44, 49, 54, 59, 64, 70, 76, 82, 88, 96, 104, 112, 120},
{0, 20, 23, 26, 28, 30, 32, 34, 36, 37, 38, 39, 40, 41, 42, 43, 44, 45, 46, 47, 48, 49, 50, 52, 54, 56, 58, 60, 62, 64, 67, 70, 120},
{0, 50, 53, 56, 58, 60, 62, 64, 66, 67, 68, 69, 70, 71, 72, 73, 74, 75, 76, 77, 78, 79, 80, 82, 84, 86, 88, 90, 92, 94, 97, 100, 120},
{0, 80, 83, 86, 89, 91, 93, 95, 96, 97, 98, 99, 100, 101, 102, 103, 104, 105, 106, 107, 108, 109, 110, 111, 112, 113, 114, 115, 116, 117, 118, 119, 120}
}.

Optionally, the audio signal is a dual-channel signal.

The method further includes:
determining a first total scale value based on the scale factor and a sub-band bandwidth of each sub-band included in the target sub-band set;
performing mid/side-stereo transform coding on the spectrum of the dual-channel signal, to obtain a transformed spectrum of the dual-channel signal;
determining a transformed scale factor of each sub-band in the target sub-band set based on the transformed spectral value of the dual-channel signal in each sub-band included in the target sub-band set;
determining a second total scale value based on the transformed scale factor and the sub-band bandwidth of each sub-band included in the target sub-band set; and
if the first total scale value is not greater than the second total scale value, determining the dual-channel signal as a to-be-encoded signal.

Optionally, the method further includes:
if the first total scale value is greater than the second total scale value, and the encoding bit rate of the audio signal is not less than the first bit rate threshold, and/or the energy concentration of the audio signal is greater than the concentration threshold, determining the transformed dual-channel signal as a to-be-encoded signal.

Optionally, the scale factor includes a left-channel scale factor and a right-channel scale factor.

The method further includes:
if the first total scale value is greater than the second total scale value, the encoding bit rate of the audio signal is less than the first bit rate threshold, and the energy concentration of the audio signal is not greater than the concentration threshold, determining, based on a left-channel scale factor and a right-channel scale factor of each sub-band included in the target sub-band set, a difference value between the left channel scale factor and the right channel scale factor of each sub-band included in the target sub-band set;
determining, based on an initial frequency and a cut-off frequency of each sub-band included in the target sub-band set, a sub-band center frequency of each sub-band included in the target sub-band set; and
if there is at least one sub-band, in the target sub-band set, that has a difference value between a left channel scale factor and a right channel scale factor greater than a difference threshold and whose sub-band center frequency is within a first range, determining the dual-channel signal as a to-be-encoded signal.

Optionally, the method further includes:
if the at least one sub-band does not exist in the target sub-band set, determining the transformed dual-channel signal as a to-be-encoded signal.

According to a second aspect, an audio signal processing apparatus is provided. The audio signal processing apparatus has a function of implementing the audio signal processing method in the first aspect. The audio signal processing apparatus includes one or more modules, and the one or more modules are configured to implement the audio signal processing method in the first aspect.

According to a third aspect, an audio signal processing device is provided. The audio signal processing device includes a processor and a memory. The memory is configured to store a program used to perform the audio signal processing method in the first aspect, and store data used to implement the audio signal processing method in the first aspect. The processor is configured to execute the program stored in the memory. The audio signal processing device may further include a communication bus, and the communication bus is configured to establish a connection between the processor and the memory.

According to a fourth aspect, a computer-readable storage medium is provided. The computer-readable storage medium stores instructions, and when the instructions are run on a computer, the computer is enabled to perform the audio signal processing method in the first aspect.

According to a fifth aspect, a computer program product including instructions is provided. When the computer program product runs on a computer, the computer is enabled to perform the audio signal processing method in the first aspect.

Technical effect achieved in the second aspect, the third aspect, the fourth aspect, and the fifth aspect are similar to that achieved by corresponding technical means in the first aspect. Details are not described again herein.

### BRIEF DESCRIPTION OF DRAWINGS

FIG. 1 is a diagram of a Bluetooth interconnection scenario according to an embodiment of this application;

FIG. 2 is a diagram of a system architecture related to an audio signal processing method according to an embodiment of this application;

FIG. 3A and FIG. 3B are a diagram of an audio encoding/decoding overall framework according to an embodiment of this application;

FIG. 4 is a diagram of a structure of an electronic device according to an embodiment of this application;

FIG. 5 is a flowchart of an audio signal processing method according to an embodiment of this application;

FIG. 6 is a diagram of relationships between sub-bands indicated in a first group of sub-band division manners and initial frequencies according to an embodiment of this application;

FIG. 7 is a diagram of relationships between sub-bands indicated in a second group of sub-band division manners and initial frequencies according to an embodiment of this application;

FIG. 8 is a diagram of relationships between sub-bands indicated in a third group of sub-band division manners and initial frequencies according to an embodiment of this application;

FIG. 9 is a diagram of relationships between sub-bands indicated in a fourth group of sub-band division manners and initial frequencies according to an embodiment of this application;

FIG. 10 is a flowchart of a method for determining whether MS transform has a gain according to an embodiment of this application; and

FIG. 11 is a diagram of a structure of an audio signal processing apparatus according to an embodiment of this application.

### DESCRIPTION OF EMBODIMENTS

To make objectives, technical solutions, and advantages of embodiments of this application clearer, the following further describes implementations of this application in detail with reference to accompanying drawings.

First, an implementation environment and background knowledge related to embodiments of this application are described.

As wireless Bluetooth devices like true wireless stereo (true wireless stereo, TWS) headsets, smart speakers, and smart watches are widely popularized and used in people's daily life, people's requirements for high-quality audio playing experience in various scenarios become increasingly urgent, especially in environments where Bluetooth signals are vulnerable to interference, for example, subways, airports, and railway stations. In a Bluetooth interconnection scenario, because a Bluetooth channel connecting an audio sending device and an audio receiving device limits a size of transmitted data. An audio encoder in the audio sending device performs data compression on an audio signal, and then transmits the audio signal to the audio receiving device. The compressed audio signal can be played only after being decoded by an audio decoder in the audio receiving device. It can be learned that, while the wireless Bluetooth devices are popularized, various audio codecs are also promoted to flourish.

Currently, Bluetooth audio codecs include a sub-band encoder (sub-band coding, SBC), an advanced audio encoder (advanced audio coding, AAC), an aptX series encoder, a low-latency high-definition audio codec (low-latency hi-definition audio codec, LHDC), a low-energy low-latency LC3 audio codec, LC3plus, and the like.

It should be understood that an audio signal processing method provided in embodiments of this application may be applied to the audio sending device (namely, an encoder side) and the audio receiving device (namely, a decoder side) in the Bluetooth interconnection scenario.

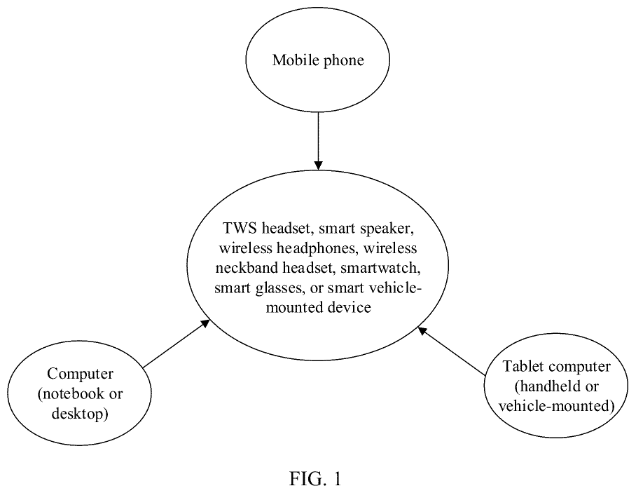

FIG. 1 is a diagram of a Bluetooth interconnection scenario according to an embodiment of this application. Refer to FIG. 1. An audio sending device in the Bluetooth interconnection scenario may be a mobile phone, a computer, a tablet computer, or the like. The computer may be a notebook computer, a desktop computer, or the like, and the tablet computer may be a handheld tablet computer, a vehicle-mounted tablet computer, or the like. An audio receiving device in the Bluetooth interconnection scenario may be a TWS headset, a smart speaker, wireless headphones, a wireless neckband headset, a smartwatch, smart glasses, a smart vehicle-mounted device, or the like. In some other embodiments, the audio receiving device in the Bluetooth interconnection scenario may alternatively be a mobile phone, a computer, a tablet computer, or the like.

It should be noted that, in addition to the Bluetooth interconnection scenario, the audio signal processing method provided in embodiments of this application may also be applied to another device interconnection scenario. In other words, a system architecture and a service scenario that are described in embodiments of this application are intended to describe the technical solutions in embodiments of this application more clearly, and do not constitute a limitation on the technical solutions provided in embodiments of this application. A person of ordinary skill in the art may learn that the technical solutions provided in embodiments of this application are also applicable to a similar technical problem as the system architecture evolves and a new service scenario emerges.

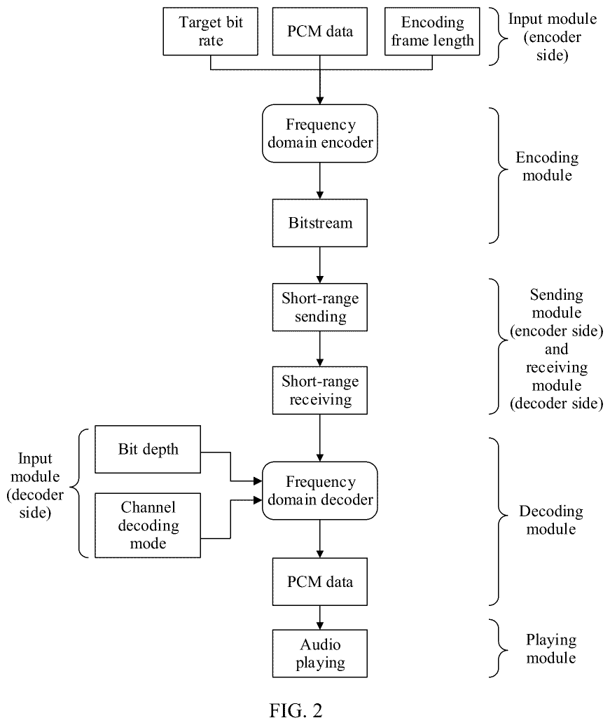

FIG. 2 is a diagram of a system architecture related to an audio signal processing method according to an embodiment of this application. Refer to FIG. 2. The system includes an encoder side and a decoder side. The encoder side includes an input module, an encoding module, and a sending module. The decoder side includes a receiving module, an input module, a decoding module, and a playing module.

At the encoder side, a user determines one encoding mode from two encoding modes based on a usage scenario, where the two encoding modes are a low-latency encoding mode and a high-sound-quality encoding mode. Encoding frame lengths of the two encoding modes are 5 ms and 10 ms respectively. For example, if the usage scenario is playing a game, live broadcasting, or making a call, the user may select the low-latency encoding mode; or if the usage scenario is enjoying music, or the like through a headset or a speaker, the user may select the high-sound-quality encoding mode. The user further needs to provide a to-be-encoded audio signal (pulse code modulation (pulse code modulation, PCM) data shown in FIG. 2) to the encoder side. In addition, the user further needs to set a target bit rate of a bitstream obtained through encoding, namely, an encoding bit rate of the audio signal. A higher target bit rate indicates better sound quality, but poorer anti-interference performance of a bitstream in a short-range transmission process. A lower target bit rate indicates poorer sound quality, but better anti-interference performance of a bitstream in a short-range transmission process. In brief, the input module at the encoder side obtains the encoding frame length, the encoding bit rate, and the to-be-encoded audio signal that are submitted by the user.

The input module at the encoder side inputs data submitted by the user into a frequency domain encoder of the encoding module.

The frequency domain encoder of the encoding module performs encoding based on the received data, to obtain a bitstream. A frequency domain encoder side analyzes the to-be-encoded audio signal, to obtain signal characteristics (including a mono/dual-channel signal, a stable/non-stable signal, a full-bandwidth/narrow-bandwidth signal, a subjective/objective signal, and the like). The audio signal enters a corresponding encoding processing submodule based on the signal characteristics and a bit rate level (namely, the encoding bit rate). The encoding processing submodule encodes the audio signal, and packages a packet header (including a sampling rate, a channel number, an encoding mode, a frame length, and the like) of the bitstream, to finally obtain the bitstream.

The sending module at the encoder side sends the bitstream to the decoder side. Optionally, the sending module is a short-range sending module shown in FIG. 2 or another type of sending module. This is not limited in embodiments of this application.

At the decoder side, after receiving the bitstream, the receiving module at the decoder side sends the bitstream to a frequency domain decoder of the decoding module, and notifies the input module at the decoder side to obtain a configured bit depth, a configured channel decoding mode, or the like. Optionally, the receiving module is a short-range receiving module shown in FIG. 2 or another type of receiving module. This is not limited in embodiments of this application.

The input module at the decoder side inputs obtained information such as the bit depth and the sound channel decoding mode into the frequency domain decoder of the decoding module.

The frequency domain decoder of the decoding module decodes the bitstream based on the bit depth, the channel decoding mode, and the like, to obtain required audio data (the PCM data shown in FIG. 2), and sends the obtained audio data to the playing module. The playing module plays audio. The sound channel decoding mode indicates a channel that needs to be decoded.

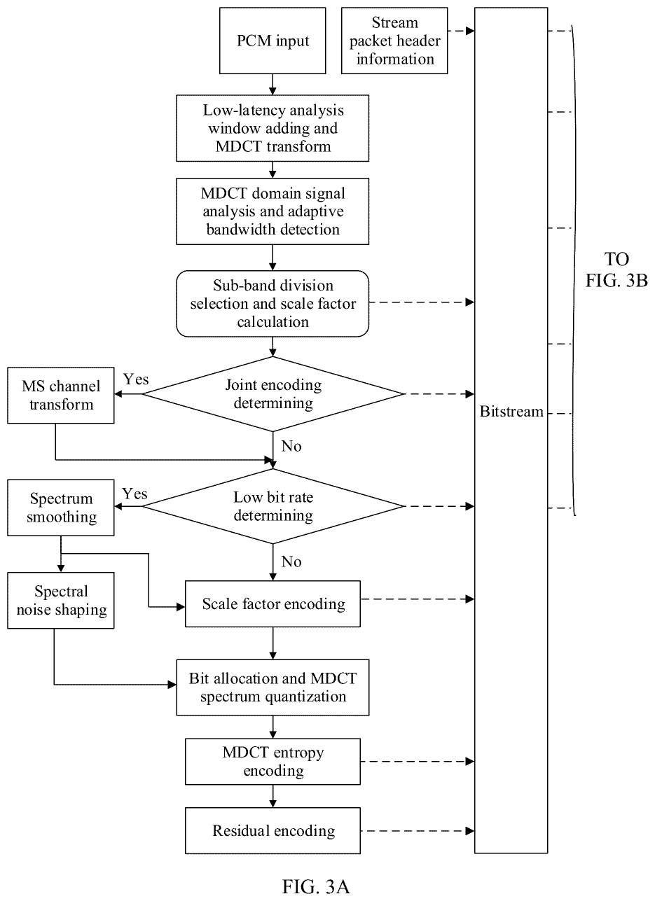

FIG. 3A and FIG. 3B are a diagram of an audio encoding/decoding overall framework according to an embodiment of this application. Refer to FIG. 3A and FIG. 3B. An encoding procedure at an encoder side includes the following steps.

### (1) PCM Input Module

PCM data is input. The PCM data is mono-channel data or dual-channel data, and a bit depth may be 16 bits (bits), 24 bits, a 32-bit floating point number, or a 32-bit fixed point number. Optionally, the PCM input module converts the input PCM data to a same bit depth, for example, a bit depth of 24 bits, performs deinterleaving on the PCM data, and then places the deinterleaved PCM data on a left channel and a right channel.

### (2) Low-Latency Analysis Window Adding Module and Modified Discrete Cosine Transform (Modified Discrete Cosine Transform, MDCT) Transform Module

A low-latency analysis window is added to and MDCT transform is performed on the PCM data processed in step (1), to obtain spectrum data in an MDCT domain. The window is added to prevent spectrum leakage.

### (3) MDCT Domain Signal Analysis Module and Adaptive Bandwidth Detection Module

The MDCT domain signal analysis module takes effect in a full bit rate scenario, and the adaptive bandwidth detection module is activated at a low bit rate (for example, a bit rate<150 kbps/channel). First, bandwidth detection is performed on the spectrum data in the MDCT domain obtained in step (2), to obtain a cut-off frequency or an effective bandwidth. Then, signal analysis is performed on spectrum data within the effective bandwidth, that is, whether frequency distribution is centralized or even is analyzed to obtain an energy concentration, and a flag (flag) indicating whether an audio signal to be encoded is an objective signal or a subjective signal (the flag of the objective signal is 1, and the flag of the subjective signal is 0) is obtained based on the energy concentration. If the audio signal is the objective signal, spectral noise shaping (spectral noise shaping, SNS) processing and MDCT spectrum smoothing are not performed on a scale factor at a low bit rate, because this reduces encoding effect of the objective signal. Then, whether to perform a sub-band cut-off operation in the MDCT domain is determined based on a bandwidth detection result and the flag of the subjective signal and the flag of the objective signal. If the audio signal is the objective signal, the sub-band cut-off operation is not performed; or if the audio signal is the subjective signal and the bandwidth detection result is identified as 0 (in a full bandwidth), the sub-band cut-off operation is determined based on a bit rate; or if the audio signal is the subjective signal and the bandwidth detection result is not identified as 0 (that is, a bandwidth is less than half of a limited bandwidth of a sampling rate), the sub-band cut-off operation is determined based on the bandwidth detection result.

### (4) Sub-Band Division Selection and Scale Factor Calculation Module

Based on a bit rate level, and the flag of the subjective signal and the flag of objective signal and the cut-off frequency that are obtained in step (3), an optimal sub-band division manner is selected from a plurality of sub-band division manners, and a total number of sub-bands for encoding the audio signal is obtained. In addition, an envelope of a spectrum is obtained through calculation, that is, scale factors corresponding to the selected sub-band division manner is calculated.

### (5) MS Channel Transform Module

For the dual-channel PCM data, joint encoding determining is performed based on the scale factors calculated in step (4), that is, whether to perform MS channel transform on the left-channel data and the right-channel data is determined.

### (6) Spectrum Smoothing Module and Scale Factor-Based Spectral Noise Shaping Module

The spectrum smoothing module performs MDCT spectrum smoothing based on a setting of the low bit rate (for example, the bit rate<150 kbps/channel), and the spectral noise shaping module performs, based on the scale factors, spectral noise shaping on data on which spectrum smoothing is performed, to obtain adjustment factors, where the adjustment factors are used to quantize spectral values of the audio signal. The setting of the low bit rate is controlled by a low bit rate determining module. When the setting of the low bit rate is not met, spectrum smoothing and spectral noise shaping do not need to be performed.

### (7) Scale Factor Encoding Module

Differential encoding or entropy encoding is performed on scale factors of a plurality of sub-bands based on distribution of the scale factors.

### (8) Bit Allocation and MDCT Spectrum Quantization and Entropy Encoding Module

Based on the scale factors obtained in step (4) and the adjustment factors obtained in step (6), encoding is controlled to be in a constant bit rate (constant bit rate, CBR) encoding mode according to a bit allocation strategy of rough estimation and precise estimation, and quantization and entropy encoding are performed on an MDCT spectral value.

### (9) Residual Encoding Module

If bit consumption in step (8) does not reach a target bit, importance sorting is further performed on sub-bands that are not encoded, and a bit is preferably allocated to encoding of an MDCT spectral value of an important sub-band.

### (10) Stream Packet Header Information Packaging Module

Packet header information includes an audio sampling rate (for example, 44.1 kHz/48 kHz/88.2 kHz/96 kHz), channel information (for example, mono channel and dual channel), an encoding frame length (for example, 5 ms and 10 ms), an encoding mode (for example, a time domain mode, a frequency domain mode, a time domain-to-frequency domain mode, or a frequency domain-to-time domain mode), and the like.

### (11) Bitstream (Namely, Bitstream) Sending Module

The bitstream includes the packet header, side information, a payload, and the like. The packet header carries the packet header information, and the packet header information is as described in step (10). The side information includes information such as the encoded bitstream of the scale factor, information about the selected sub-band division manner, cut-off frequency information, a low bit rate flag, joint encoding determining information (namely, an MS transform flag), and a quantization step. The payload includes the encoded bitstream and a residual encoded bitstream of the MDCT spectrum.

A decoding procedure at a decoder side includes the following steps.

### (1) Stream Packet Header Information Parsing Module

The stream packet header information parsing module parses the packet header information from the received bitstream, where the packet header information includes information such as the sampling rate, the channel information, the encoding frame length, and the encoding mode of the audio signal; and obtains the encoding bit rate through calculation based on a bitstream size, the sampling rate, and the encoding frame length, that is, obtains bit rate level information.

### (2) Scale Factor Decoding Module

The scale factor decoding module decodes the side information from the bitstream. The side information includes information, such as the information about the selected sub-band division manner, the cut-off frequency information, the low bit rate flag, the joint encoding determining information, the quantization step, and the scale factors of the sub-bands.

### (3) Scale Factor-Based Spectral Noise Shaping Module

At the low bit rate (for example, the encoding bit rate less than 300 kbps, namely, 150 kbps/channel), spectral noise shaping further needs to be performed based on the scale factors, to obtain the adjustment factors. The adjustment factors are used to dequantize decoded spectral values. The setting of the low bit rate is controlled by the low bit rate determining module. When the setting of the low bit rate is not met, spectral noise shaping does not need to be performed.

### (4) MDCT Spectrum Decoding Module and Residual Decoding Module

The MDCT spectrum decoding module decodes the MDCT spectrum data in the decoded bitstream based on the information about the sub-band division manner, the quantization step information, and the scale factors obtained in step (2). Hole padding is performed at a low bit rate level, and if a bit obtained through calculation is still remaining, the residual decoding module performs residual decoding, to obtain MDCT spectrum data of another sub-band, so as to obtain final MDCT spectrum data.

### (5) LR Channel Conversion Module

Based on the side information obtained in step (2), if it is determined, according to the joint encoding determining information, that a dual-channel joint encoding mode rather than a decoding low-energy mode (for example, the encoding bit rate is greater than or equal to 300 kbps/channel and the sampling rate is greater than 88.2 kHz) is used, LR channel conversion is performed on the MDCT spectrum data obtained in step (4).

### (6) Inverse MDCT Transform Module, Low-Latency Synthesis Window Adding Module, and Overlap-Add Module

On the basis of step (4) and step (5), an inverse MDCT transform module performs MDCT inverse transform on the obtained MDCT spectrum data to obtain a time-domain aliased signal. Then, the low-latency synthesis window module adds a low-latency synthesis window to the time-domain aliased signal. The overlap-add module superimposes time-domain aliased buffer signals of a current frame and a previous frame to obtain a PCM signal, that is, obtains the final PCM data based on an overlap-add method.

### (7) PCM Output Module

The PCM output module outputs PCM data of a corresponding channel based on a configured bit depth and channel decoding mode.

It should be noted that the audio encoding/decoding framework shown in FIG. 3A and FIG. 3B is merely used as an example of a terminal in embodiments of this application, and is not intended to limit embodiments of this application. A person skilled in the art may obtain another encoding/decoding framework on the basis of FIG. 3A and FIG. 3B.

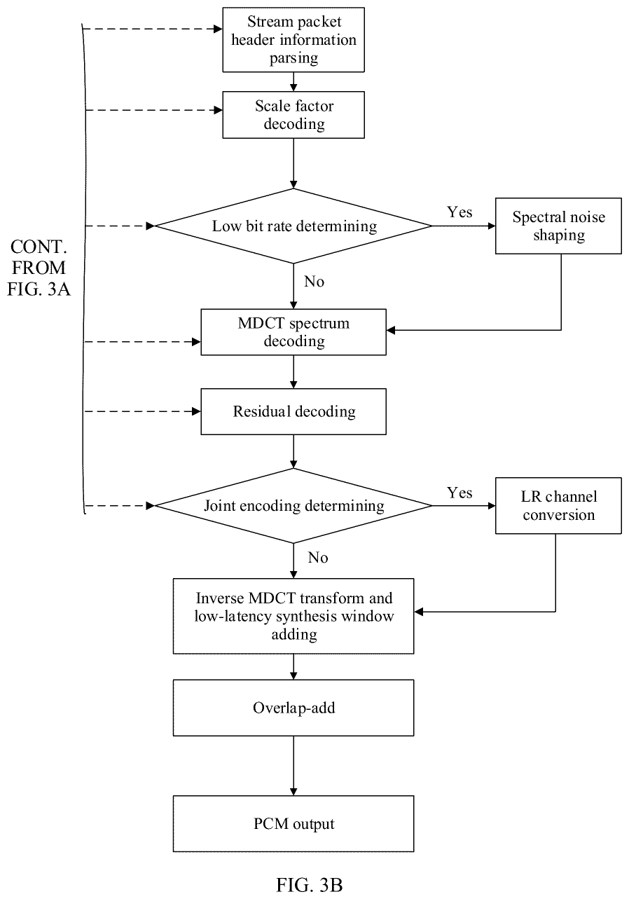

FIG. 4 is a diagram of a structure of an electronic device according to an embodiment of this application. Optionally, the electronic device is any device shown in FIG. 1, and includes one or more processors 401, a communication bus 402, a memory 403, and one or more communication interfaces 404.

The processor 401 is a general-purpose central processing unit (central processing unit, CPU), a network processor (network processor, NP), a microprocessor, or one or more integrated circuits configured to implement the solutions of this application, for example, an application-specific integrated circuit (application-specific integrated circuit, ASIC), a programmable logic device (programmable logic device, PLD), or a combination thereof. Optionally, the PLD is a complex programmable logic device (complex programmable logic device, CPLD), a field-programmable gate array (field-programmable gate array, FPGA), generic array logic (generic array logic, GAL), or any combination thereof.

The communication bus 402 is configured to transmit information between the foregoing components. Optionally, the communication bus 402 may be classified into an address bus, a data bus, a control bus, or the like. For ease of representation, only one thick line is used to represent the bus in the figure, but this does not mean that there is only one bus or only one type of bus.

Optionally, the memory 403 is a read-only memory (read-only memory, ROM), a random access memory (random access memory, RAM), an electrically erasable programmable read-only memory (electrically erasable programmable read-only memory, EEPROM), an optical disc (including a compact disc read-only memory (compact disc read-only memory, CD-ROM), a compact disc, a laser disc, a digital versatile disc, a Blu-ray disc, or the like), a magnetic disk storage medium or another magnetic storage device, or any other medium that can be used to carry or store expected program code in a form of instructions or a data structure and that is accessible to a computer. However, this is not limited hereto. The memory 403 exists independently, and is connected to the processor 401 through the communication bus 402, or the memory 403 is integrated with the processor 401.

The communication interface 404 is configured to communicate with another device or a communication network by using any apparatus like a transceiver. The communication interface 404 includes a wired communication interface, or may optionally include a wireless communication interface. The wired communication interface is, for example, an Ethernet interface. Optionally, the Ethernet interface is an optical interface, an electrical interface, or a combination thereof. The wireless communication interface is a wireless local area network (wireless local area network, WLAN) interface, a cellular network communication interface, a combination thereof, or the like.

Optionally, in some embodiments, the electronic device includes a plurality of processors, for example, the processor 401 and a processor 405 shown in FIG. 4. Each of these processors is a single-core processor or a multi-core processor. Optionally, the processor herein is one or more devices, circuits, and/or processing cores for processing data (for example, computer program instructions).

During specific implementation, in an embodiment, the electronic device further includes an output device 406 and an input device 407. The output device 406 communicates with the processor 401, and can display information in a plurality of manners. For example, the output device 406 is a liquid crystal display (liquid crystal display, LCD), a light emitting diode (light emitting diode, LED) display device, a cathode ray tube (cathode ray tube, CRT) display device, or a projector (projector). The input device 407 communicates with the processor 401, and can receive an input of a user in a plurality of manners. For example, the input device 407 is a mouse, a keyboard, a touchscreen device, or a sensing device.

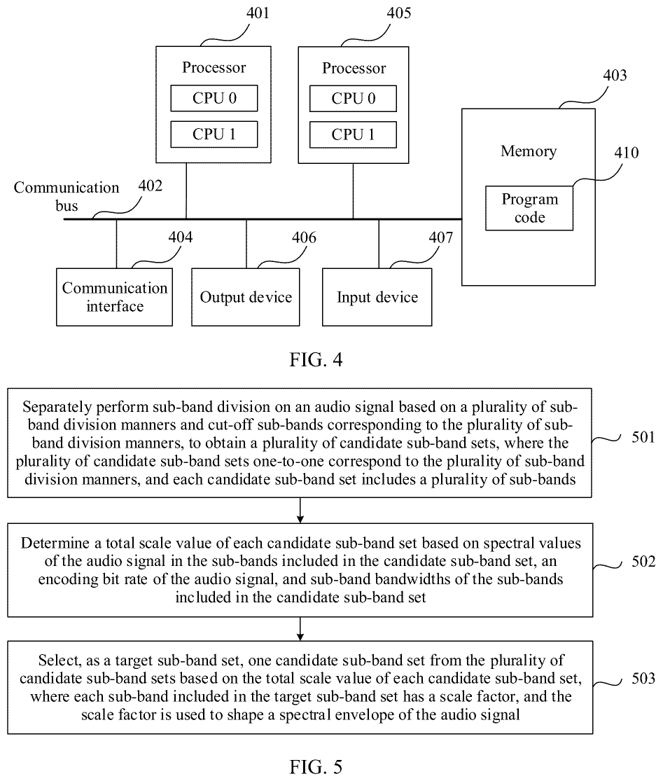

In some embodiments, the memory 403 is configured to store program code 410 for executing the solutions of this application, and the processor 401 can execute the program code 410 stored in the memory 403. The program code includes one or more software modules, and the electronic device can implement, by using the processor 401 and the program code 410 in the memory 403, the audio signal processing method provided in the following embodiment in FIG. 5.

FIG. 5 is a flowchart of an audio signal processing method according to an embodiment of this application. The method is applied to an encoder side. Refer to FIG. 5. The method includes the following steps.

Step 501: Separately perform sub-band division on an audio signal based on a plurality of sub-band division manners and cut-off sub-bands corresponding to the plurality of sub-band division manners, to obtain a plurality of candidate sub-band sets, where the plurality of candidate sub-band sets one-to-one correspond to the plurality of sub-band division manners, and each candidate sub-band set includes a plurality of sub-bands.

In embodiments of this application, the encoder side separately performs sub-band division on the audio signal based on the plurality of sub-band division manners and the cut-off sub-bands corresponding to the plurality of sub-band division manners, to obtain the plurality of candidate sub-band sets, so as to select an optimal sub-band division manner from the plurality of sub-band division manners.

Any one of the plurality of sub-band division manners is used as an example. A total number of sub-bands indicated by the sub-band division manner is 32, and a number of cut-off sub-bands corresponding to the sub-band division manner is 16, indicating that a cut-off frequency of the audio signal is in a 16th sub-band. For example, a complete bandwidth of the audio signal is 16 kilohertz (kHz). The cut-off sub-band indicates that the cut-off frequency of the audio signal is 5 kHz. After sub-band division is performed on the audio signal based on the sub-band division manner, an obtained candidate sub-band set includes 16 sub-bands in total, and a frequency range covered by the 16 sub-bands is from 0 kHz to 5 kHz, that is, a range of [0, cut-off frequency] is covered.

It should be noted that a sub-band division process is performed on audio frames one by one. The audio signal described in this specification may be considered as an audio frame. It is clear that the encoder side can perform sub-band division on each audio frame according to this solution.

In embodiments of this application, there are a plurality of implementations in which the encoder side obtains the cut-off sub-band. One of the implementations is described herein.

If an encoding bit rate of the audio signal is less than a first bit rate threshold, the encoder side performs bandwidth detection on a spectrum of the audio signal, to obtain the cut-off frequency of the audio signal. The encoder side determines, based on the cut-off frequency, the cut-off sub-bands respectively corresponding to the plurality of sub-band division manners. It should be understood that, when the encoding bit rate is low, a number of encoding bits that can be allocated is small. Therefore, the encoder side determines the cut-off frequency through bandwidth detection, and further determines the cut-off sub-band. In this case, a spectral value that exceeds the cut-off frequency is not encoded subsequently, so that a requirement on the encoding bit rate is met while encoding effect is ensured.

There are a plurality of manners in which the encoder side performs bandwidth detection. In an implementation, because a value of a frequency that is in the spectrum of the audio signal and that is located after the cut-off frequency is zero, the encoder side sequentially traverses values of frequencies in the spectrum from a high frequency to a low frequency, where a value of a 1^{st} traversed frequency that is greater than an energy threshold is the cut-off frequency of the audio signal.

Optionally, the encoder side takes a logarithm (for example, log 10) of the values of the frequencies in the spectrum, sequentially traverses, from a high frequency to a low frequency, values of the frequencies that are obtained after the logarithm is taken, and determines, as the cut-off frequency of the audio signal, the value of the 1^{st} traversed frequency that is obtained after the logarithm is taken and that is greater than the energy threshold. Optionally, the energy threshold is −50 dB, −80 dB, or another value.

In addition, when the audio signal is a mono-channel signal, the encoder side performs bandwidth detection on a mono-channel spectrum of the audio signal, to obtain the cut-off frequency of the audio signal. When the audio signal is a dual-channel signal, the encoder side separately performs bandwidth detection on a left-channel spectrum and a right-channel spectrum of the audio signal, to obtain a left-channel cut-off frequency and a right-channel cut-off frequency. If the left-channel cut-off frequency is inconsistent with the right-channel cut-off frequency, the encoder side determines, as the cut-off frequency of the audio signal, a larger value in the left-channel cut-off frequency and the right-channel cut-off frequency. If the left-channel cut-off frequency is consistent with the right-channel cut-off frequency, the encoder side determines the left-channel cut-off frequency as the cut-off frequency of the audio signal.

In some other embodiments, the encoder side may alternatively perform bandwidth detection on the spectrum in another manner. This is not limited in this solution.

Optionally, after obtaining the cut-off frequency of the audio signal, the encoder side determines, based on a location of the cut-off frequency in the complete bandwidth of the audio signal, the cut-off sub-bands respectively corresponding to the plurality of sub-band division manners.

For example, the cut-off frequency is located at a 30^{th} frequency in the complete bandwidth of the audio signal, and the 30^{th} frequency is located in a k^{th} sub-band in the plurality of sub-bands indicated by a sub-band division manner. In this case, the cut-off sub-band corresponding to the sub-band division manner is k.

Optionally, in embodiments of this application, the first bit rate threshold is 150 kbps or another value. The following uses an example in which the first bit rate threshold is 150 kbps for description. Optionally, in this embodiment of this application, the encoding bit rate of the audio signal is an encoding bit rate of a single channel, that is, the encoding bit rate of the single channel is compared with the first bit rate threshold. In some other embodiments, the first bit rate threshold may alternatively be another value. For example, the first bit rate threshold is 150 kbps. When the audio signal is a dual-channel signal, the encoding bit rate of the audio signal is an encoding bit rate of a left channel or an encoding bit rate of a right channel. The encoding bit rate of the left channel is usually the same as the encoding bit rate of the right channel. In this case, the encoder side only needs to compare the encoding bit rate of the left channel with 150 kbps.

It is clear that in some other embodiments, when the audio signal is a dual-channel signal, the encoding bit rate of the audio signal is an encoding bit rate of the dual channel. Correspondingly, the first bit rate threshold is 300 kbps.

Optionally, if the encoding bit rate of the audio signal is not less than the first bit rate threshold, the encoder side determines, as a cut-off sub-band corresponding to each sub-band division manner, a last sub-band indicated by each of the plurality of sub-band division manners. It should be understood that, when the encoding bit rate is high, the number of encoding bits that can be allocated is large. Therefore, even if the encoder side does not perform bandwidth detection, the requirement on the encoding bit rate can still be met, and encoding efficiency can be further improved to some extent. Certainly, in some other embodiments, the encoder side may alternatively perform bandwidth detection on the spectrum of the audio signal whose encoding bit rate is not less than the first bit rate threshold.

In embodiments of this application, before separately performing sub-band division on the audio signal based on the plurality of sub-band division manners and the cut-off sub-bands corresponding to the plurality of sub-band division manners, the encoder side performs feature analysis on the spectrum of the audio signal, to obtain a feature analysis result; and determines the plurality of sub-band division manners from a plurality of candidate sub-band division manners based on the feature analysis result and the encoding bit rate of the audio signal. In other words, the encoder side preliminarily selects the plurality of sub-band division manners from the plurality of candidate sub-band division manners through frequency-domain feature analysis, and subsequently selects an optimal sub-band division manner from the plurality of sub-band division manners.

Optionally, the feature analysis result includes a subjective signal flag or an objective signal flag, the subjective signal flag indicates that an energy concentration of the audio signal is not greater than a concentration threshold, and the objective signal flag indicates that the energy concentration of the audio signal is greater than the concentration threshold. In other words, the feature analysis includes subjective and objective signal analysis, and the encoder side preliminarily selects the plurality of sub-band division manners based on analysis results of the subjective and objective signals and the encoding bit rate.

The following describes an implementation of subjective and objective signal analysis.

In embodiments of this application, the encoder side performs subjective and objective signal analysis based on a part that is of the spectrum of the audio signal and that does not exceed the cut-off frequency, to reduce a calculation amount and improve efficiency while ensuring accuracy.

The encoder side takes a logarithm, with 10 as the base, of each value of a frequency that does not exceed the cut-off frequency in the spectrum, to obtain a logarithm result of each frequency. The encoder side normalizes the logarithm result of each frequency to a dBFS scale, to obtain a logarithm result of each frequency on the dBFS scale. The encoder side determines a first frequency number and a second frequency number. The first frequency number is a total number of frequencies whose logarithm results are not greater than the energy threshold on the dBFS scale, and the second frequency number is a total number of frequencies, in the spectrum, that do not exceed the cut-off frequency. The encoder side determines, as the energy concentration of the audio signal, a ratio of the first frequency number to the second frequency number. If the energy concentration of the audio signal is greater than the concentration threshold, the encoder side determines that the audio signal is an objective signal, and outputs an objective signal flag. If total energy of the audio signal is not greater than the concentration threshold, the encoder side determines that the audio signal is a subjective signal, and outputs a subjective signal flag.

For example, the encoder side takes, according to a formula (1), the logarithm, with 10 as the base, of each value of the frequency that does not exceed the cut-off frequency in the spectrum, to obtain the logarithm result of each frequency.

$$X lg ( k ) = 20 {log}_{10} ( abs ( X ( k ) ) ) , \\ k = 0 , 1 , … , cutOffFreq \qquad ( 1 )$$

In the formula (1), X(k) indicates a value of a k^{th} frequency, that is, a k^{th} spectral value, cutOffFreq indicates a frequency corresponding to the cut-off frequency, that is, the second frequency number, abs ( ) indicates an absolute value, and Xlg(k) indicates a logarithm result of the k^{th} frequency.

The encoder side normalizes the logarithm result of each frequency to the dBFS scale according to a formula (2), to obtain the logarithm result of each frequency on the dBFS scale.

$$XdBFS ( k ) = X lg ( k ) - 20 {log}_{10} ( abs ( {X}_{m ax} ) ) , \\ k = 0 , 1 , … , cutOffFreq \qquad ( 2 )$$

In the formula (2), XdBFS(k) indicates a logarithm result of the k^{th} frequency on the dBFS scale, and Xmax indicates a maximum spectral value that does not exceed the cut-off frequency in the spectrum.

The encoder side collects statistics on a total number of frequencies whose logarithm results are not greater than −80 dB on the dBFS scale, to obtain the first frequency number low EnergyCnt, where −80 dB indicates an energy threshold, and the energy threshold is obtained through statistics collection or in another manner. The encoder side determines the energy concentration energyRate of the audio signal according to a formula (3).

$$energyRate = \frac{lowEnergyCnt}{cutOffFreq} \qquad ( 3 )$$

The encoder side outputs a subjective and objective signal flag objFlag according to a formula (4). When objFlag is 1, it indicates an objective signal flag. When objFlag is 0, it indicates a subjective signal flag.

$$objFlag = \{ \begin{matrix}1 , & energyRate > threshold \\ 0 , & energyRate \leq threshold\end{matrix} \qquad ( 4 )$$

In the formula (4), threshold indicates a concentration threshold.

In this embodiment of this application, the concentration threshold is 0.6, and the concentration threshold is obtained through statistics collection or in another manner. For example, the concentration ratio threshold is a constant parameter obtained based on signal distribution of bandwidths with different grades. It is clear that in some other embodiments, the concentration threshold may alternatively be another value.

It should be understood that the foregoing example is used as an implementation of subjective and objective signal analysis, and is not intended to limit embodiments of this application.

In another implementation, after obtaining the first frequency number and the second frequency number, the encoder side determines, as the energy concentration of the audio signal, a ratio of the second frequency number to the first frequency number. If the energy concentration of the audio signal is less than the concentration threshold, the encoder side determines that the audio signal is an objective signal, and outputs an objective signal flag. If total energy of the audio signal is not less than the concentration threshold, the encoder side determines that the audio signal is a subjective signal, and outputs a subjective signal flag. The concentration threshold in this implementation is the reciprocal of the concentration threshold in the previous implementation. In other words, from a perspective that a proportion of an amount of non-background noise energy (namely, the first frequency number) is less than a threshold, it indicates that a frequency domain feature of the objective signal is strong. The essence of this implementation is the same as that of the previous implementation.

In still another implementation, the encoder side does not normalize a logarithm result of each frequency to a dBFS scale, but directly determines a third frequency number. The third frequency number is a total number of frequencies whose logarithm results are not greater than the energy threshold. Then, the encoder side determines, as an energy concentration of the audio signal, a ratio of the third frequency number to the second frequency number. It should be noted that the energy threshold in this implementation is different from the energy threshold on the dBFS scale in the first implementation.

In still another implementation, the encoder side does not take the logarithm, with 10 as the base, of values of frequencies that do not exceed the cut-off frequency in the spectrum, but directly collects statistics on a total number of frequencies that do not exceed the energy threshold in a spectrum range that does not exceed the cut-off frequency in the spectrum, to obtain a fourth frequency number. Then, the encoder side determines, as an energy concentration of the audio signal, a ratio of the fourth frequency number to the second frequency number. It should be noted that the energy threshold and the concentration threshold in this implementation are different from the energy threshold and the concentration threshold in the foregoing several implementations.

It should be understood that taking the logarithm with 10 as the base and normalizing to the dBFS scale are for performing an operation on different scales. The scale conversion is an optional operation at the encoder side, and energy thresholds and concentration thresholds on different scales are different.

The following describes an implementation process in which the encoder side preliminarily selects the plurality of sub-band division manners based on the feature analysis result and the encoding bit rate.

In this embodiment of this application, the feature analysis result includes a subjective signal flag or an objective signal flag. A frame length of the audio signal is 10 milliseconds (ms), and a sampling rate is 88.2 kilohertz (kHz) or 96 kHz; or a frame length of the audio signal is 5 ms, and a sampling rate is 88.2 kHz or 96 KHz; or a frame length of the audio signal is 10 ms, and a sampling rate is 44.1 kHz or 48 kHz. In this case, if the encoding bit rate of the audio signal is less than the first bit rate threshold, and the feature analysis result includes the subjective signal flag, the encoder side determines, as the plurality of sub-band division manners, a first group of sub-band division manners in the plurality of candidate sub-band division manners. The first group of sub-band division manners are as follows:
{
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 3, 5, 7, 9, 12, 15, 18, 22, 26, 30, 35, 41, 48, 56, 65, 74, 84, 94, 106, 118, 134, 150, 166, 184, 202, 220, 240, 260, 280, 480},
{0, 1, 2, 3, 4, 5, 7, 9, 11, 14, 17, 21, 25, 29, 34, 40, 46, 52, 60, 68, 76, 86, 98, 110, 126, 144, 162, 180, 200, 224, 250, 280, 480},
{0, 2, 4, 6, 8, 12, 16, 21, 26, 31, 36, 41, 46, 51, 56, 61, 66, 71, 77, 83, 89, 95, 103, 111, 121, 131, 147, 163, 179, 203, 240, 280, 480},
{0, 1, 2, 3, 5, 7, 9, 12, 15, 19, 23, 27, 32, 37, 43, 49, 57, 66, 76, 86, 98, 110, 125, 140, 158, 176, 194, 216, 238, 264, 290, 320, 480},
{0, 1, 2, 3, 5, 7, 10, 13, 17, 21, 25, 30, 35, 41, 47, 54, 62, 70, 80, 90, 102, 114, 130, 146, 162, 180, 198, 218, 240, 264, 290, 320, 480},
{0, 1, 2, 4, 6, 8, 11, 14, 18, 22, 26, 30, 36, 42, 50, 58, 66, 76, 88, 100, 112, 128, 144, 160, 182, 204, 226, 256, 286, 316, 352, 400, 480},
{0, 1, 2, 4, 6, 8, 11, 14, 18, 22, 26, 30, 36, 42, 50, 58, 68, 78, 90, 102, 116, 132, 148, 166, 186, 208, 234, 262, 292, 324, 360, 400, 480}
}.

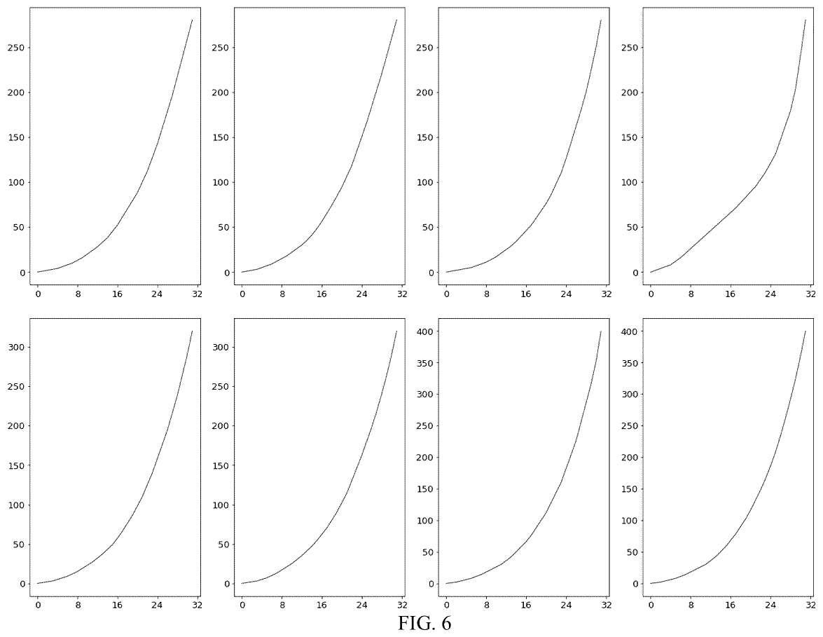

FIG. 6 shows relationships between sub-bands indicated by the eight sub-band division manners included in the first group of sub-band division manners and initial frequencies of the sub-bands.

A frame length of the audio signal is 10 ms, and a sampling rate is 88.2 kHz or 96 kHz; or a frame length of the audio signal is 5 ms, and a sampling rate is 88.2 kHz or 96 kHz; or a frame length of the audio signal is 10 ms, and a sampling rate is 44.1 kHz or 48 kHz. In this case, if the encoding bit rate of the audio signal is not less than the first bit rate threshold, and/or the feature analysis result includes the objective signal flag, the encoder side determines, as the plurality of sub-band division manners, a second group of sub-band division manners in the plurality of candidate sub-band division manners. The second group of sub-band division manners are as follows:
{
{0, 1, 2, 3, 4, 5, 6, 7, 8, 10, 12, 14, 16, 19, 22, 26, 30, 35, 40, 45, 50, 57, 64, 73, 82, 92, 102, 112, 124, 136, 148, 160, 480},
{0, 1, 2, 3, 4, 5, 7, 9, 11, 13, 15, 18, 21, 24, 28, 33, 38, 44, 50, 57, 64, 73, 82, 93, 104, 116, 128, 140, 155, 170, 185, 200, 480},
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 4, 6, 10, 14, 18, 22, 26, 30, 34, 42, 50, 58, 66, 74, 84, 96, 108, 120, 136, 152, 168, 192, 216, 240, 272, 304, 336, 376, 424, 480},
{0, 1, 2, 4, 6, 10, 14, 18, 26, 34, 42, 50, 62, 74, 86, 98, 112, 128, 144, 160, 176, 196, 216, 236, 256, 280, 304, 328, 352, 384, 416, 448, 480},
{0, 80, 92, 104, 112, 120, 128, 136, 144, 148, 152, 156, 160, 164, 168, 172, 176, 180, 184, 188, 192, 196, 200, 208, 216, 224, 232, 240, 248, 256, 268, 280, 480},
{0, 200, 212, 224, 232, 240, 248, 256, 264, 268, 272, 276, 280, 284, 288, 292, 296, 300, 304, 308, 312, 316, 320, 328, 336, 344, 352, 360, 368, 376, 388, 400, 480},
{0, 320, 332, 344, 356, 364, 372, 380, 384, 388, 392, 396, 400, 404, 408, 412, 416, 420, 424, 428, 432, 436, 440, 444, 448, 452, 456, 460, 464, 468, 472, 476, 480}
}.

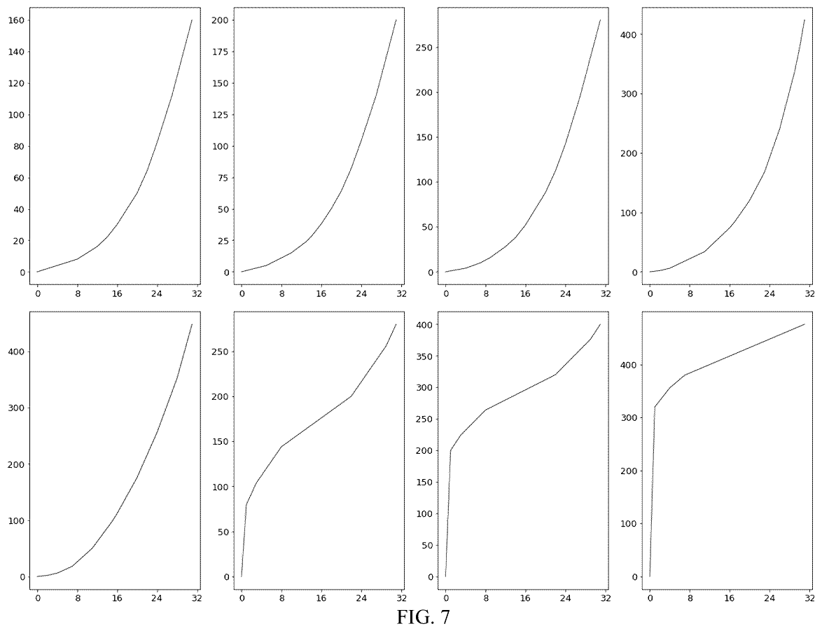

FIG. 7 shows relationships between sub-bands indicated by the eight sub-band division manners included in the second group of sub-band division manners and initial frequencies of the sub-bands.

It should be noted that, when the frame length of the audio signal is 10 ms and the sampling rate is 88.2 kHz or 96 kHz, a spectrum of each audio frame included in the audio signal includes 960 frequencies. In a process of performing sub-band division based on the second group of sub-band division manners, the encoder side multiplies each sub-band division value in the second group of sub-band division manners by 2, to obtain sub-band division values corresponding to the 960 frequencies, and performs sub-band division based on the sub-band division values corresponding to the 960 frequencies. When the frame length of the audio signal is 5 ms, and the sampling rate is 88.2 kHz or 96 KHz; or when the frame length of the audio signal is 10 ms, and the sampling rate is 44.1 kHz or 48 kHz, because a spectrum of each audio frame included in the audio signal includes 480 frequencies, a last sub-band division value in each sub-band division manner included in the second group of sub-band division manners is also 480. Therefore, the encoder side directly performs sub-band division based on the second group of sub-band division manners.

A frame length of the audio signal is 5 ms, and a sampling rate is 44.1 kHz or 48 kHz. In this case, if the encoding bit rate of the audio signal is less than the first bit rate threshold, and the feature analysis result includes the subjective signal flag, the encoder side determines, as the plurality of sub-band division manners, a third group of sub-band division manners in the plurality of candidate sub-band division manners. The third group of sub-band division manners are as follows:
{
{0, 1, 2, 3, 4, 5, 6, 7, 8, 9, 10, 12, 14, 16, 19, 22, 26, 30, 35, 39, 44, 50, 56, 63, 71, 80, 89, 98, 108, 119, 129, 140, 240},
{0, 1, 2, 3, 4, 5, 6, 7, 8, 9, 11, 13, 15, 17, 20, 24, 28, 32, 37, 42, 47, 53, 59, 67, 75, 83, 92, 101, 110, 120, 130, 140, 240},
{0, 1, 2, 3, 4, 5, 6, 7, 8, 9, 10, 11, 12, 14, 17, 20, 23, 26, 30, 34, 38, 43, 49, 55, 63, 72, 81, 90, 100, 112, 125, 140, 240},
{0, 1, 2, 3, 4, 6, 8, 10, 13, 15, 18, 20, 23, 25, 28, 30, 33, 35, 38, 41, 44, 47, 51, 55, 60, 65, 73, 81, 89, 101, 120, 140, 240},
{0, 1, 2, 3, 4, 5, 6, 7, 9, 11, 13, 14, 16, 18, 21, 24, 28, 33, 38, 43, 49, 55, 62, 70, 79, 88, 97, 108, 119, 132, 145, 160, 240},
{0, 1, 2, 3, 4, 5, 6, 7, 8, 10, 12, 14, 17, 20, 23, 27, 31, 35, 40, 45, 51, 57, 65, 73, 81, 90, 99, 109, 120, 132, 145, 160, 240},
{0, 1, 2, 3, 4, 5, 6, 7, 9, 11, 13, 15, 18, 21, 25, 29, 33, 38, 44, 50, 56, 64, 72, 80, 91, 102, 113, 128, 143, 158, 176, 200, 240},
{0, 1, 2, 3, 4, 5, 6, 7, 9, 11, 13, 15, 18, 21, 25, 29, 34, 39, 45, 51, 58, 66, 74, 83, 93, 104, 117, 131, 146, 162, 180, 200, 240}
}.

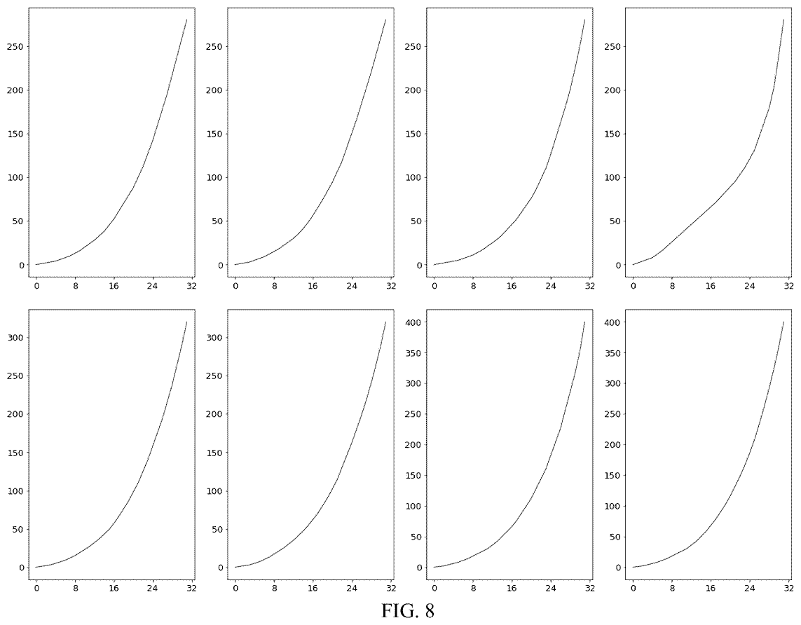

FIG. 8 shows relationships between sub-bands indicated by the eight sub-band division manners included in the third group of sub-band division manners and initial frequencies of the sub-bands.

A frame length of the audio signal is 5 ms, and a sampling rate is 44.1 kHz or 48 kHz. In this case, if the encoding bit rate of the audio signal is not less than the first bit rate threshold, and/or the feature analysis result includes the objective signal flag, the encoder side determines, as the plurality of sub-band division manners, a fourth group of sub-band division manners in the plurality of candidate sub-band division manners. The fourth group of sub-band division manners are as follows:
{
{0, 1, 2, 3, 4, 5, 6, 7, 8, 9, 10, 11, 12, 13, 14, 15, 16, 17, 18, 19, 20, 21, 22, 23, 24, 26, 28, 30, 32, 34, 37, 40, 120},
{0, 1, 2, 3, 4, 5, 6, 7, 8, 9, 10, 11, 12, 13, 14, 15, 16, 18, 20, 22, 24, 26, 28, 30, 32, 34, 36, 38, 41, 44, 47, 50, 120},
{0, 1, 2, 3, 4, 5, 6, 7, 8, 9, 10, 11, 12, 14, 16, 18, 20, 22, 24, 26, 28, 31, 34, 37, 40, 44, 48, 52, 56, 60, 65, 70, 120},
{0, 1, 2, 3, 4, 5, 6, 7, 8, 9, 10, 11, 12, 13, 15, 17, 19, 21, 24, 27, 30, 34, 38, 42, 48, 54, 60, 68, 76, 84, 94, 106, 120},
{0, 1, 2, 3, 4, 5, 6, 7, 8, 10, 12, 14, 16, 19, 22, 25, 28, 32, 36, 40, 44, 49, 54, 59, 64, 70, 76, 82, 88, 96, 104, 112, 120},
{0, 20, 23, 26, 28, 30, 32, 34, 36, 37, 38, 39, 40, 41, 42, 43, 44, 45, 46, 47, 48, 49, 50, 52, 54, 56, 58, 60, 62, 64, 67, 70, 120},
{0, 50, 53, 56, 58, 60, 62, 64, 66, 67, 68, 69, 70, 71, 72, 73, 74, 75, 76, 77, 78, 79, 80, 82, 84, 86, 88, 90, 92, 94, 97, 100, 120},
{0, 80, 83, 86, 89, 91, 93, 95, 96, 97, 98, 99, 100, 101, 102, 103, 104, 105, 106, 107, 108, 109, 110, 111, 112, 113, 114, 115, 116, 117, 118, 119, 120}
}.

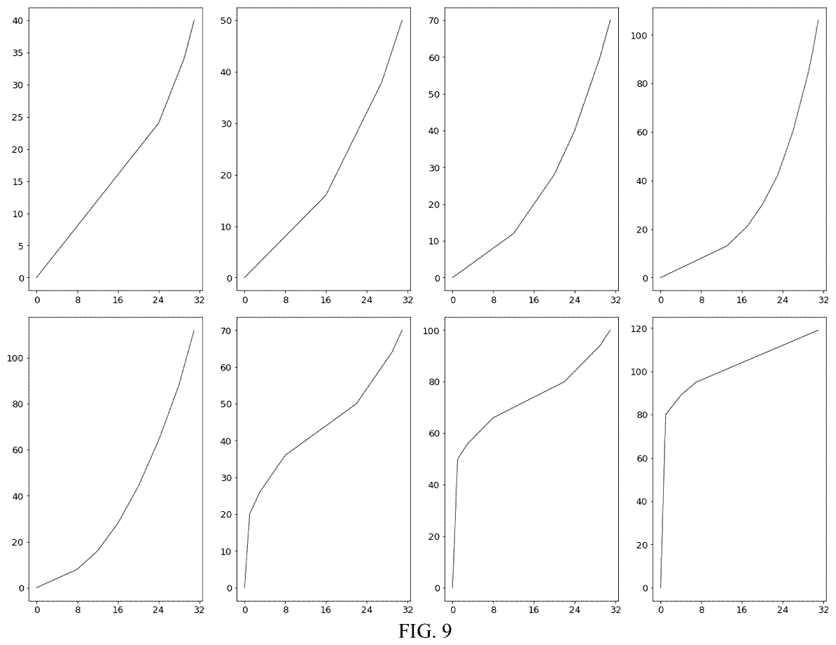

FIG. 9 shows relationships between sub-bands indicated by the eight sub-band division manners included in the fourth group of sub-band division manners and initial frequencies of the sub-bands.

It should be noted that, when the frame length of the audio signal is 5 ms and the sampling rate is 44.1 kHz or 48 kHz, a spectrum of each audio frame included in the audio signal includes 240 frequencies. In a process of performing sub-band division based on the fourth group of sub-band division manners, the encoder side multiplies each sub-band division value in the fourth group of sub-band division manners by 2, to obtain sub-band division values corresponding to the 240 frequencies, and performs sub-band division based on the sub-band division values corresponding to the 240 frequencies.

It should be noted that each sub-band division manner provided in embodiments of this application complies with a Bark (Bark) requirement. The Bark scale indicates that a sub-band division policy of a spectrum is dividing sub-bands in terms of hearing based on a human ear auditory characteristic.

Step 502: Determine a total scale value of each candidate sub-band set based on spectral values of the audio signal in the sub-bands included in the candidate sub-band set, the encoding bit rate of the audio signal, and sub-band bandwidths of the sub-bands included in the candidate sub-band set.

In embodiments of this application, after obtaining the plurality of candidate sub-band sets that one-to-one correspond to the plurality of sub-band division manners, the encoder side determines the total scale value of each candidate sub-band set based on the spectral values of the audio signal in the sub-bands included in the candidate sub-band set, the encoding bit rate of the audio signal, and the sub-band bandwidths of the sub-bands included in the candidate sub-band set.

Optionally, an implementation process in which the encoder side determines the total scale value of each candidate sub-band set based on the spectral values of the audio signal in the sub-bands included in the candidate sub-band set, the encoding bit rate of the audio signal, and the sub-band bandwidths of the sub-bands included in the candidate sub-band set includes: For a first candidate sub-band set in the plurality of candidate sub-band sets, the encoder side determines, based on spectral values of the audio signal in sub-bands included in the first candidate sub-band set, a scale factor of each sub-band included in the first candidate sub-band set. The first candidate sub-band set is any one of the plurality of candidate sub-band sets. Then, the encoder side determines a total scale value of the first candidate sub-band set based on the encoding bit rate of the audio signal, and the scale factor and a sub-band bandwidth of each sub-band included in the first candidate sub-band set. It should be noted that, for each candidate sub-band set other than the first candidate sub-band set in the plurality of candidate sub-band sets, the encoder side determines a total scale value of each of the other candidate sub-band sets in a same manner as determining the total scale value of the first candidate sub-band set.

There are a plurality of implementations in which the encoder side determines the scale factor of each sub-band. In an implementation, an implementation process in which the encoder side determines, based on the spectral values of the audio signal in sub-bands included in the first candidate sub-band set, the scale factor of each sub-band included in the first candidate sub-band set includes: For a first sub-band included in the first candidate sub-band set, the encoder side obtains a maximum value in absolute values of all spectral values of the audio signal in the first sub-band, and determines a scale factor of the first sub-band based on the maximum value. The first sub-band is any sub-band in the first candidate sub-band set. It should be noted that, for each sub-band other than the first sub-band in the first candidate sub-band set, the encoder side determines a scale factor of each of the other sub-bands in a same manner as determining the scale factor of the first sub-band.

For example, the encoder side determines a scale factor of each sub-band in the first candidate sub-band set according to a formula (5).

$$E ( b ) = ceil [ {log}_{2} ( {max}_{I ( b ) \leq k \leq I ( b + 1 ) - 1} abs ( X ( k ) ) ) ] \qquad ( 5 )$$

$$b = 0 , 1 , … , B - 1$$

In the formula (5), X(k) indicates the k^{th} spectral value of the audio signal, b indicates a sequential number of a sub-band, I(b) indicates an initial frequency of the sub-band b, B indicates a cut-off sub-band corresponding to the first candidate sub-band set, that is, a total number of sub-bands included in the first candidate sub-band set, abs( ) indicates obtaining an absolute value, max( ) indicates obtaining a maximum value, ceil( ) indicates rounding up, and I( ) indicates a scale factor of a sub-band.

The following describes an implementation in which the encoder side determines the total scale value of the first candidate sub-band set based on the encoding bit rate of the audio signal, and the scale factor and the sub-band bandwidth of each sub-band included in the first candidate sub-band set.

Optionally, the encoding bit rate of the audio signal is not less than the first bit rate threshold, and/or the energy concentration of the audio signal is greater than the concentration threshold. The encoder side determines an energy smooth reference value based on the encoding bit rate of the audio signal and a second bit rate threshold. The encoder side determines, based on the energy smooth reference value, and the scale factor and the sub-band bandwidth of each sub-band included in the first candidate sub-band set, the total energy value of each sub-band included in the first candidate sub-band set. The encoder side adds up the total energy values of the sub-bands included in the first candidate sub-band set, to obtain the total scale value of the first candidate sub-band set. If the energy concentration of the audio signal is greater than the concentration threshold, it indicates that the audio signal is an objective signal. It should be understood that, when the encoding bit rate is high, and/or the audio signal is an objective signal, the encoder side determines the total scale value based on the total energy value of each sub-band.

In embodiments of this application, there are a plurality of implementations in which the encoder side determines the energy smooth reference value. One of the implementations is described herein. In this implementation, the encoder side determines the energy smooth reference value according to a formula (6).

$${E}_{floor} = int [ min ( ( ( 200 - bpsPerChn ) ) , 0 ) ] \qquad ( 6 )$$

In the formula (6), E_{floor} indicates the energy smooth reference value; bpsPerChn indicates the encoding bit rate of the audio signal, where the encoding bit rate of the audio signal is an encoding bit rate of a single channel; 200 indicates that the second bit rate threshold is 200 kbps; min( ) indicates obtaining a minimum value; and int( ) indicates rounding down. It should be noted that the second bit rate threshold may alternatively be another value.

There a plurality of implementations in which the encoder side determines, based on the energy smooth reference value, and the scale factor and the sub-band bandwidth of each sub-band included in the first candidate sub-band set, the total energy value of each sub-band included in the first candidate sub-band set. One of the implementations is described herein. In this implementation, for the first sub-band included in the first candidate sub-band set, the encoder side determines, as a reference scale value of the first sub-band, a larger value in the scale factor of the first sub-band and the energy smooth reference value. The encoder side determines, as a total energy value of the first sub-band, a product of the reference scale value of the first sub-band and a sub-band bandwidth of the first sub-band. The first sub-band is any sub-band in the first candidate sub-band set. It should be noted that, for each sub-band other than the first sub-band in the first candidate sub-band set, the encoder side determines a total energy value of each of the other sub-bands in a same manner as determining the total energy value of the first sub-band.

The encoder side determines, according to a formula (7), a total energy value of each sub-band included in the first candidate sub-band set, and the total scale value of the first candidate sub-band set.

$${E}_{total} = {\sum }_{b = 0}^{B - 1} max [ E ( b ) , {E}_{floor} ] * bandWidth ( b ) \qquad ( 7 )$$

In the formula (7), b indicates a sequential number of a sub-band, B indicates the cut-off sub-band corresponding to the first candidate sub-band set, bandWidth( ) indicates the sub-band bandwidth, F(b) indicates a scale factor of the sub-band b, E_{floor} indicates the energy smooth reference value, max( ) indicates obtaining a maximum value, max[E(b), E_{floor}]*bandWidth(b) indicates a total energy value of the sub-band b, and Eₜₒₜₐₗ indicates a total scale value of the first sub-band set.

The foregoing describes an implementation process in which the encoder side determines the total scale value of the first candidate sub-band set when the encoding bit rate of the audio signal is not less than the first bit rate threshold, and/or the energy concentration of the audio signal is greater than the concentration threshold. The following describes an implementation process in which the encoder side determines the total scale value of the first candidate sub-band set when the encoding bit rate of the audio signal is less than the first bit rate threshold, and the energy concentration of the audio signal is not greater than the concentration threshold.

If the encoding bit rate of the audio signal is less than the first bit rate threshold, and the energy concentration of the audio signal is not greater than the concentration threshold, the implementation process in which the encoder side determines the total scale value of the first candidate sub-band set based on the encoding bit rate of the audio signal, and the scale factor and the sub-band bandwidth of each sub-band included in the first candidate sub-band set includes: The encoder side determines the energy smooth reference value based on the encoding bit rate of the audio signal and the second bit rate threshold. The encoder side determines, based on the energy smooth reference value and the scale factor of each sub-band included in the first candidate sub-band set, scale difference values of the sub-bands included in the first candidate sub-band set. The scale difference value indicates a difference between a scale factor of a corresponding sub-band and a scale factor of an adjacent sub-band of the corresponding sub-band. The encoder side determines the total scale value of the first candidate sub-band set based on the scale difference values of the sub-bands included in the first candidate sub-band set and the sub-band bandwidth of each sub-band. If the energy concentration of the audio signal is not greater than the concentration threshold, it indicates that the audio signal is a subjective signal. It should be understood that, when the encoding bit rate is low, and the audio signal is a subjective signal, the encoder side determines the total scale value based on a difference between each sub-band and an adjacent sub-band.

For the implementation in which the encoder side determines the energy smooth reference value based on the encoding bit rate of the audio signal and the second bit rate threshold, refer to the foregoing related descriptions. Details are not described herein again.

There a plurality of implementations in which the encoder side determines, based on the energy smooth reference value and the scale factor of each sub-band included in the first candidate sub-band set, the scale difference values of the sub-bands included in the first candidate sub-band set. One of the implementations is described herein. In this implementation, for the first sub-band included in the first candidate sub-band set, the encoder side determines a first smooth value, a second smooth value, and a third smooth value of the first sub-band based on the energy smooth reference value, the scale factor of the first sub-band, and a scale factor of an adjacent sub-band of the first sub-band. The encoder side determines a scale difference value of the first sub-band based on the first smooth value, the second smooth value, and the third smooth value of the first sub-band. The first sub-band is any sub-band in the first candidate sub-band set.

Optionally, if the first sub-band is an initial sub-band in the first candidate sub-band set, the encoder side determines, as the first smooth value of the first sub-band, a larger value in the scale factor of the first sub-band and the energy smooth reference value; or if the first sub-band is not an initial sub-band in the first candidate sub-band set, determines, as the first smooth value of the first sub-band, a larger value in a scale factor of a previous sub-band adjacent to the first sub-band and the energy smooth reference value.

The encoder side determines, as the second smooth value of the first sub-band, a larger value in the scale factor of the first sub-band and the energy smooth reference value.

If the first sub-band is a last sub-band in the first candidate sub-band set, the encoder side determines, as the third smooth value of the first sub-band, a larger value in the scale factor of the first sub-band and the energy smooth reference value; or if the first sub-band is not a last sub-band in the first candidate sub-band set, determines, as the third smooth value of the first sub-band, a larger value in a scale factor of a next sub-band adjacent to the first sub-band and the energy smooth reference value.

In other words, the encoder side determines a first smooth value, a second smooth value, and a third smooth value of each sub-band according to a formula (8), a formula (9), and a formula (10).

$$left ( b ) = \{ \begin{matrix}\begin{matrix}max [ E ( b - 1 ) , {E}_{floor} ] , & if b \neq 0 \\ center ( b ) , & if b = 0\end{matrix} , & for b = 0 , 1 , 2 , … , B - 1\end{matrix} \qquad ( 8 )$$

$$center ( b ) = \begin{matrix}max [ E ( b ) , {E}_{floor} ] , & for b = 0 , 1 , 2 , … , B - 1\end{matrix} \qquad ( 9 )$$

$$righr ( b ) = \{ \begin{matrix}\begin{matrix}max [ E ( b + 1 ) , {E}_{floor} ] , & if b \neq B - 1 \\ center ( b ) , & if b = B - 1\end{matrix} , & for b = 0 , 1 , 2 , … , B - 1\end{matrix} \qquad ( 10 )$$

In the formula (8), the formula (9), and the formula (10), left( ), center( ), and right( ) respectively indicate the first smooth value, the second smooth value, and the third smooth value. In this embodiment of this application, the first smooth value, the second smooth value, and the third smooth value may also be respectively referred to as a left smooth value, an intermediate smooth value, and a right smooth value.

Optionally, an implementation process in which the encoder side determines the scale difference value of the first sub-band after determining the first smooth value, the second smooth value, and the third smooth value of the first sub-band includes: For the first sub-band included in the first candidate sub-band set, the encoder side determines a first difference value and a second difference value of the first sub-band. The first difference value is an absolute value of a difference value between the first smooth value and the second smooth value of the first sub-band, and the second difference value is an absolute value of a difference value between the second smooth value and the third smooth value of the first sub-band. The encoder side determines the scale difference value of the first sub-band based on the first difference value and the second difference value of the first sub-band. The first sub-band is any sub-band in the first candidate sub-band set.

For example, the encoder side determines the scale difference value of the first sub-band according to a formula (11).

$${E}_{diff} = max \{ 8 - abs [ center ( b ) - left ( b ) ] - abs [ center ( b ) - right ( b ) ] , 1 \} \qquad ( 11 )$$

$$b = 0 , 1 , … , B - 1$$

An implementation process in which the encoder side determines the total scale value of the first candidate sub-band set based on the scale difference value and the sub-band bandwidth of each sub-band after determining the scale difference value of each sub-band included in the first candidate sub-band set includes: The encoder side determines, based on a number of sub-bands included in the first candidate sub-band set and the sub-band bandwidth of each sub-band, a smooth weighting coefficient of each sub-band included in the first candidate sub-band set. The encoder side adds up the smooth weighting coefficients of the sub-bands included in the first candidate sub-band set, to obtain a total smooth weighting coefficient of the first candidate sub-band set. The encoder side multiplies the scale difference values of the sub-bands included in the first candidate sub-band set by the smooth weighting coefficients, to obtain weighted scale difference values of the sub-bands included in the first candidate sub-band set. The encoder side adds up the weighted scale difference values of the sub-bands included in the first candidate sub-band set, to obtain a summation scale value of the first candidate sub-band set. The encoder side divides the summation scale value by the total smooth weighting coefficient of the first candidate sub-band set, to obtain the total scale value of the first candidate sub-band set.

The step in which the encoder side determines the smooth weighting coefficient of each sub-band and the total smooth weighting coefficient of the first candidate sub-band set may alternatively be performed before the scale difference value of each sub-band is determined. A sequence of the steps performed by the encoder side is not limited in embodiments of this application.

Optionally, the encoder side determines a scaling coefficient of sub-band division based on the number of sub-bands included in the first candidate sub-band set. The encoder side determines, based on the scaling coefficient of sub-band division and the sub-band bandwidth of each sub-band included in the first candidate sub-band set, the smooth weighting coefficient of each sub-band included in the first candidate sub-band set.

For example, the encoder side determines the scaling coefficient coef of sub-band division according to a formula (12).

$$coef = \frac{1}{0.8 * B} \qquad ( 12 )$$

The encoder side determines the smooth weighting coefficient frac of each sub-band according to a formula (13).

frac(b)=max{min[bands Width(b)*max[(1−b*cofe),0.05],4.0],1.0} b=0,1, . . . ,B−1 (13)

The encoder side determines the total smooth weighting coefficient sum of the first candidate sub-band set according to a formula (14).

$$sum = {\sum }_{b = 0}^{B - 1} frac ( b ) \qquad ( 14 )$$

The encoder side determines the summation scale value Eₜₒₜₐₗ of the first candidate sub-band set according to a formula (15).

$${E}_{total}^{′} = {\sum }_{b = 0}^{B - 1} {E}_{diff} ( b ) * frac ( b ) \qquad ( 15 )$$

E_{diff}(b)*frac (b) indicates a weighted scale difference value of the sub-band b.

The encoder side determines the total scale value Eₜₒₜₐₗ of the first candidate sub-band set according to a formula (16).

$${E}_{total} = \frac{{E}_{total}^{′}}{sum} \qquad ( 16 )$$

It should be noted that, when the audio signal is a mono-channel signal, the encoder side may calculate a total scale value of each candidate sub-band set according to the foregoing formulas. When the audio signal is a dual-channel signal, the spectrum of the audio signal includes the left-channel spectrum and the right-channel spectrum, and the encoder side calculates the total scale value of each candidate sub-band set based on the left-channel spectrum and the right-channel spectrum. For example, the encoder side adds a total scale value calculated based on the left-channel spectrum and a total scale value calculated based on the right-channel spectrum, to obtain the total scale value of the candidate sub-band set. In an implementation, another summation 2 is added to the foregoing formula related to summation 2, and the added summation 2 Indicates that related data of the left channel and related data of the right channel are added.

Step 503: Select, as a target sub-band set, one candidate sub-band set from the plurality of candidate sub-band sets based on the total scale value of each candidate sub-band set, where each sub-band included in the target sub-band set has a scale factor, and the scale factor is used to shape a spectral envelope of the audio signal.

In embodiments of this application, the encoder side determines, as the target sub-band set, a candidate sub-band set with a smallest total scale value in the plurality of candidate sub-band sets. In some other embodiments, the encoder side may alternatively determine, as the target sub-band set, a candidate sub-band set with a second smallest total scale value in the plurality of candidate sub-band sets. The second smallest total scale value is a smallest total scale value in the scale values other than the smallest total scale value.

It can be learned from the foregoing that the encoder side selects an optimal sub-band division manner from the plurality of sub-band division manners based on a characteristic of the audio signal. In other words, the sub-band division manner has a signal adaptation characteristic, and helps improve coding effect and compression efficiency.

To further improve coding effect and compression efficiency, when the audio signal is a dual-channel signal, the encoder side can further determine, based on the determined target sub-band set, whether coding performance can be improved by performing mid/side stereo transform coding (Mid/Side stereo transform coding, MS transform) on the spectrum of the audio signal. Further, if it is determined that MS transform helps improve coding performance, the encoder side performs a subsequent encoding procedure based on a spectrum obtained through MS transform. If it is determined that MS transform does not help improve coding performance, the encoder side performs a subsequent encoding procedure based on the original spectrum of the audio signal. This is described below.

In embodiments of this application, when the audio signal is a dual-channel signal, the encoder side determines a first total scale value based on the scale factor and the sub-band bandwidth of each sub-band included in the target sub-band set. The encoder side performs MS transform on the spectrum of the dual-channel signal, to obtain a transformed spectrum of the dual-channel signal. The encoder side determines a transformed scale factor of each sub-band in the target sub-band set based on the transformed spectral value of the dual-channel signal in each sub-band included in the target sub-band set. The encoder side determines a second total scale value based on the transformed scale factor and the sub-band bandwidth of each sub-band included in the target sub-band set. If the first total scale value is not greater than the second total scale value, the encoder side determines the dual-channel signal (the dual-channel signal before MS transform) as a to-be-encoded signal.

It should be understood that the first total scale value is the total scale value before MS transform, and the second total scale value is a total scale value obtained through MS transform. A higher total scale value indicates a lower coding performance gain. The first total scale value being not greater than the second total scale value indicates that MS transform does not help improve coding performance. Therefore, the encoder side determines the dual-channel signal before MS transform as the to-be-encoded signal.

Optionally, the spectrum of the dual-channel signal before MS transform is referred to as an LR spectrum, and the spectrum, obtained through MS transform, of the dual-channel signal is referred to as an MS spectrum. LR indicates the left and right channels.

When the audio signal is the dual-channel signal, the scale factor includes a left-channel scale factor and a right-channel scale factor. Optionally, an implementation process in which the encoder side determines the first total scale value based on the scale factor and the sub-band bandwidth of each sub-band included in the target sub-band set includes: The encoder side determines, as a left-channel energy value of a corresponding sub-band, a product of a left-channel scale factor of each sub-band included in the target sub-band set and a sub-band bandwidth of the corresponding sub-band; and determines, as a right-channel energy value of the corresponding sub-band, a product of a right-channel scale factor of each sub-band included in the target sub-band set and the sub-band bandwidth of the corresponding sub-band. The encoder side adds up left-channel energy values and right-channel energy values of all sub-bands included in the target sub-band set, to obtain the first total scale value.

For example, the encoder side determines the first total scale value according to a formula (17).

$$totalScale 1 = {\sum }_{ch = 0}^{1} {\sum }_{b = 0}^{B - 1} E ( b ) * bandWidth ( b ) \qquad ( 17 )$$

In the formula (17), totalScale1 indicates the first total scale value, and ch indicates sequential numbers of the left and right channels. When ch=0, E (b) indicates the left-channel scale factor. When ch=1, F (b) indicates the right-channel scale factor.

The encoder side performs MS transform according to a formula (18).

$$M = \frac{L + R}{2} , \qquad ( 18 )$$

$$S = \frac{L - R}{2}$$

In the formula (18), L and R respectively indicate a spectral value of the left channel and a spectral value of the right channel before transform. M and S respectively indicate a transformed spectral value of the left channel and a transformed spectral value of the right channel. It should be noted that the encoder side processes spectral values of corresponding frequencies in a spectrum of the left channel and a spectrum of the right channel according to the formula (18), to obtain spectral values of corresponding frequencies in a transformed spectrum of the left channel and a transformed spectrum of the right channel. The transformed spectral value of the left channel and the transformed spectral value of the right channel are spectral values of two channels included in the transformed dual-channel signal. A transformed left channel and a transformed right channel may also be referred to as a transformed M channel and a transformed S channel.

The encoder side determines the transformed scale factor of each sub-band according to a formula (19) similar to the formula (5).

$$E\_MS ( b ) = int [ {log}_{2} ( {max}_{I ( b ) \leq k \leq I ( b + 1 ) - 1} abs ( X\_MS ( k ) ) ) ] \qquad ( 19 )$$

$$b = 0 , 1 , … , B - 1$$

In the formula (19), X_MS(k) indicates a transformed k^{th} spectral value, and E_MS(b) indicates a scale factor of the sub-band b on the M channel or the S channel, namely, a scale factor of the sub-band b on a transformed channel. It should be noted that the encoder side calculates the scale factor of the M channel based on the spectral value of the M channel according to the formula (19), and calculates the scale factor of the S channel based on the spectral value of the S channel according to the formula (19).

The encoder side determines the second total scale value according to a formula (20).

$$totalScale 2 = {\sum }_{ch = 0}^{1} {\sum }_{b = 0}^{B - 1} E\_MS ( b ) * bandWidth ( b ) \qquad ( 20 )$$

In the formula (20), totalScale2 indicates the second total scale value, and ch indicates the sequential numbers of the M channel and the S channel. When ch=0, E_MS(b) indicates a scale factor of the sub-band on the transformed left channel, and when ch=1, E_MS(b) indicates a scale factor of the sub-band on the transformed right channel, namely, the scale factor of the sub-band b on the M channel or the S channel.

Optionally, if the first total scale value is greater than the second total scale value, and the encoding bit rate of the audio signal is not less than the first bit rate threshold, and/or the energy concentration of the audio signal is greater than the concentration threshold, the encoder side determines the transformed dual-channel signal as a to-be-encoded signal. It should be understood that the first total scale value being greater than the second total scale value indicates that MS transform can help improve coding performance. Therefore, the encoder side determines the dual-channel signal obtained through MS transform as the to-be-encoded signal.

It can be learned from the foregoing that, when the audio signal is a dual-channel signal, the scale factor includes the left-channel scale factor and the right-channel scale factor. Optionally, if the first total scale value is greater than the second total scale value, the encoding bit rate of the audio signal is less than the first bit rate threshold, and the energy concentration of the audio signal is not greater than the concentration threshold, the encoder side determines, based on the left-channel scale factor and the right-channel scale factor of each sub-band included in the target sub-band set, a difference value between the left channel scale factor and the right channel scale factor of each sub-band included in the target sub-band set. The encoder side determines, based on an initial frequency and a cut-off frequency of each sub-band included in the target sub-band set, a start-end frequency difference value of each sub-band included in the target sub-band set. If there is at least one sub-band, in the target sub-band set, that has a difference value between a left channel scale factor and a right channel scale factor greater than a difference threshold and whose start-end frequency difference value is within a first range, the encoder side determines the dual-channel signal before transform as a to-be-encoded signal.

In other words, when the encoding bit rate is low, and the audio signal is an objective signal, the encoder side determines, based on the difference value between the left-channel scale factor and the right-channel scale factor and the start-end frequency difference value of the sub-band, whether MS transform improves coding performance.

Optionally, the encoder side traverses all sub-bands in the target sub-band set. When there is a sub-band that has a difference value between a left channel scale factor and a right channel scale factor greater than the difference threshold and whose start-end frequency difference value is within the first range, the encoder side determines the dual-channel signal before transform as the to-be-encoded signal.

For example, the encoder side determines the difference value between the left channel scale factor and the right channel scale factor of each sub-band according to a formula (21).

$$diffSFflag ( b ) = abs [ E\_L ( b ) - E\_R ( b ) ] \qquad ( 21 )$$

In the formula (21), E_L( ) indicates the left-channel scale factor, E_R( ) indicates the right-channel scale factor, and diffSFflag( ) indicates the difference value between the left channel scale factor and the right channel scale factor.

When the encoder side determines the difference value between the left channel scale factor and the right channel scale factor of each sub-band according to the formula (21), the difference threshold is 3.

The encoder side determines the sub-band center frequency of each sub-band according to a formula (22).

$$freq ( b ) = abs [ \frac{bandstart ( b ) + bandend ( b )}{2} ] * \frac{SamplingRate}{2 * FrameLength} \qquad ( 22 )$$

In the formula (22), freq( ) indicates the start-end frequency difference value, bandstart( ) and bandend( ) respectively indicate the initial frequency and the cut-off frequency, SamplingRate indicates a sampling rate in a unit of Hz, and FrameLength indicates a quantity of sampling points in each frame.

Optionally, when the encoder side determines the sub-band center frequency of each sub-band according to the formula (22), the first range is (3500, 12000].

In brief, when the encoder side uses the formula (21) and the formula (22), the encoder side traverses all sub-bands in the target sub-band set. When there is a sub-band that has a difference value diffSFflag between a left channel scale factor and a right channel scale factor greater than 3 and whose sub-band center frequency freq is within the range of (3500, 12000], the encoder side determines the dual-channel signal before transform as the to-be-encoded signal.

If the at least one sub-band does not exist in the target sub-band set, the encoder side determines the transformed dual-channel signal as a to-be-encoded signal. The at least one sub-band is a sub-band that has a difference value between a left channel scale factor and a right channel scale factor greater than the difference threshold and whose sub-band center frequency is within the first range.

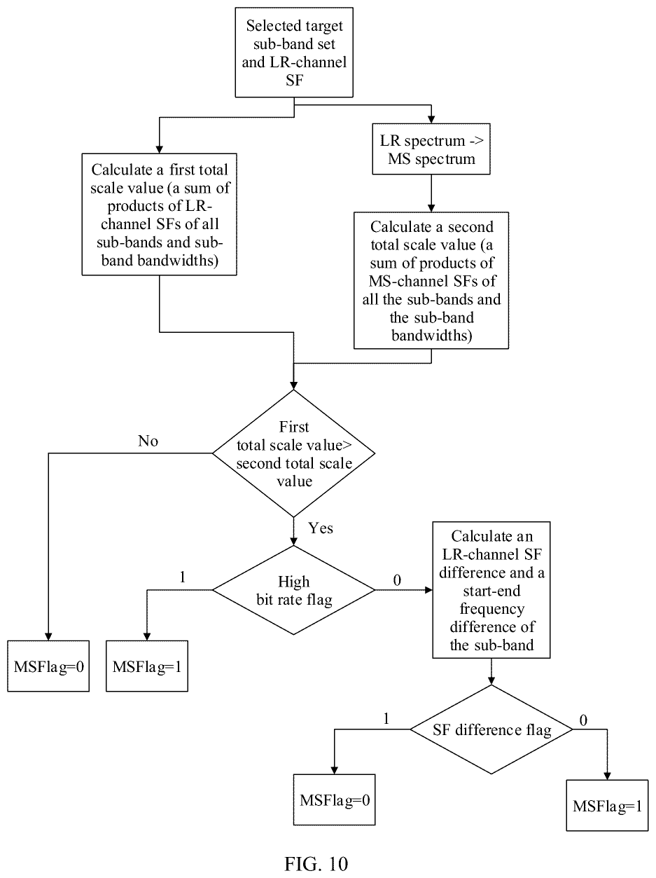

The following describes again, with reference to FIG. 10, the implementation process in which the encoder side determines whether to use the transformed dual-channel signal as the to-be-encoded signal.

Refer to FIG. 10. The encoder side calculates the first total scale value based on the selected target sub-band set and the left/right (LR)-channel scale factor (scale factor, SF) of each sub-band in the target sub-band set. The first total scale value is a sum of products of LR-channel scale factors of all the sub-bands in the target sub-band set and corresponding sub-band bandwidths. The encoder side transforms the LR-channel spectrum into the MS-channel spectrum, and calculates the second total scale value. The second total scale value is a sum of products of MS-channel scale factors of all the sub-bands in the target sub-band set and the corresponding sub-band bandwidths. If the first total scale value is not greater than the second total scale value, the encoder side determines the dual-channel signal before transform as a to-be-encoded signal, and sets MSFlag=0, indicating execution of a subsequent operation is not based on the spectral value obtained through MS transform.

If the first total scale value is greater than the second total scale value, the encoder side determines whether the audio signal (namely, the dual-channel signal before transform) meets a first condition. The first condition is that the encoding bit rate of the audio signal is less than the first bit rate threshold, and the energy concentration of the audio signal is less than the concentration threshold. If the audio signal meets the first condition, the encoder side sets a high bit rate flag to 0. If the audio signal does not meet the first condition, the encoder side sets the high bit rate flag to 1.

If the high bit rate flag is equal to 1, the encoder side determines the transformed dual-channel signal as a to-be-encoded signal, and sets MSFlag=1, indicating execution of a subsequent operation is based on the spectral value obtained through MS transform. If the high bit rate flag is equal to 0, the encoder side calculates an LR-channel SF difference value and the sub-band center frequency of each sub-band through traversing. If a sub-band obtained through traversing meets a second condition, the encoder side sets an SF difference flag to 1. The second condition is that an LR-channel SF difference value of a corresponding sub-band is less than the difference threshold, and a sub-band center frequency is within the first range. If no sub-band obtained through traversing meets the second condition, the encoder side sets the SF difference flag to 0.

If the SF difference flag is equal to 1, the encoder side determines the dual-channel signal before transform as a to-be-encoded signal, and sets MSFlag=0. If the SF difference flag is equal to 0, the encoder side determines the transformed dual-channel signal as a to-be-encoded signal, and sets MSFlag=1.

It should be noted that, in addition to the foregoing implementations in which the encoder side determines whether to use the transformed dual-channel signal as the to-be-encoded signal, the encoder side may alternatively perform determining in another manner. In other words, the foregoing implementations are not intended to limit embodiments of this application.

In conclusion, in embodiments of this application, the optimal sub-band division manner is selected from the plurality of sub-band division manners based on the characteristic of the audio signal. In other words, the sub-band division manner has the signal adaptation characteristic, and can adapt to the encoding bit rate of the audio signal, to improve the anti-interference capability. Specifically, the audio signal is divided separately based on the plurality of sub-band division manners, the total scale value corresponding to each sub-band division manner is determined based on spectral values of the audio signal in sub-bands obtained through division, the bandwidth of each sub-band, and the encoding bit rate of the audio signal, and the optimal target sub-band division manner is selected based on the total scale value, to obtain the optimal sub-band set. Subsequently, spectral envelope shaping is performed based on the scale factor of each sub-band in the optimal sub-band set, to improve coding effect and compression efficiency.

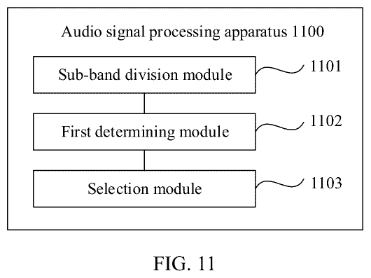

FIG. 11 is a diagram of a structure of an audio signal processing apparatus 1100 according to an embodiment of this application. The processing apparatus 1100 may be implemented as a part or the entire of an electronic device by using software, hardware, or a combination thereof. The electronic device may be any device shown in FIG. 1. Refer to FIG. 11. The apparatus includes a sub-band division module 1101, a first determining module 1102, and a selection module 1103.

The sub-band division module 1101 is configured to separately perform sub-band division on an audio signal based on a plurality of sub-band division manners and cut-off sub-bands corresponding to the plurality of sub-band division manners, to obtain a plurality of candidate sub-band sets. The plurality of candidate sub-band sets one-to-one correspond to the plurality of sub-band division manners, and each candidate sub-band set includes a plurality of sub-bands.

The first determining module 1102 is configured to determine a total scale value of each candidate sub-band set based on spectral values of the audio signal in the sub-bands included in the candidate sub-band set, an encoding bit rate of the audio signal, and sub-band bandwidths of the sub-bands included in the candidate sub-band set.

The selection module 1103 is configured to select, as a target sub-band set, one candidate sub-band set from the plurality of candidate sub-band sets based on the total scale value of each candidate sub-band set. Each sub-band included in the target sub-band set has a scale factor, and the scale factor is used to shape a spectral envelope of the audio signal.

Optionally, the selection module 1103 is configured to:
determine, as the target sub-band set, a candidate sub-band set with a smallest total scale value in the plurality of candidate sub-band sets.

Optionally, the first determining module 1102 includes:
a first determining submodule, configured to: for a first candidate sub-band set in the plurality of candidate sub-band sets, determine, based on spectral values of the audio signal in sub-bands included in the first candidate sub-band set, a scale factor of each sub-band included in the first candidate sub-band set, where the first candidate sub-band set is any one of the plurality of candidate sub-band sets; and
a second determining submodule, configured to determine a total scale value of the first candidate sub-band set based on the encoding bit rate of the audio signal, and the scale factor and a sub-band bandwidth of each sub-band included in the first candidate sub-band set.

Optionally, the second determining submodule is configured to:
for a first sub-band included in the first candidate sub-band set, obtain a maximum value in absolute values of all spectral values of the audio signal in the first sub-band, where the first sub-band is any sub-band in the first candidate sub-band set; and
determine a scale factor of the first sub-band based on the maximum value.

Optionally, the encoding bit rate of the audio signal is not less than a first bit rate threshold, and/or an energy concentration of the audio signal is greater than a concentration threshold.

The second determining submodule is configured to:
determine an energy smooth reference value based on the encoding bit rate of the audio signal and a second bit rate threshold;
determine, based on the energy smooth reference value, and the scale factor and the sub-band bandwidth of each sub-band included in the first candidate sub-band set, the total energy value of each sub-band included in the first candidate sub-band set; and
add up the total energy values of the sub-bands included in the first candidate sub-band set, to obtain the total scale value of the first candidate sub-band set.

Optionally, the second determining submodule is configured to:
for the first sub-band included in the first candidate sub-band set, determine, as a reference scale value of the first sub-band, a larger value in the scale factor of the first sub-band and the energy smooth reference value, where the first sub-band is any sub-band in the first candidate sub-band set; and
determine, as a total energy value of the first sub-band, a product of the reference scale value of the first sub-band and a sub-band bandwidth of the first sub-band.

Optionally, the encoding bit rate of the audio signal is less than a first bit rate threshold, and an energy concentration of the audio signal is not greater than a concentration threshold.

The second determining submodule is configured to:
determine an energy smooth reference value based on the encoding bit rate of the audio signal and a second bit rate threshold;
determine, based on the energy smooth reference value and the scale factor of each sub-band included in the first candidate sub-band set, scale difference values of the sub-bands included in the first candidate sub-band set, where the scale difference value indicates a difference between a scale factor of a corresponding sub-band and a scale factor of an adjacent sub-band of the corresponding sub-band; and
determine the total scale value of the first candidate sub-band set based on the scale difference values of the sub-bands included in the first candidate sub-band set and the sub-band bandwidth of each sub-band.

Optionally, the second determining submodule is configured to:
for the first sub-band included in the first candidate sub-band set, determine a first smooth value, a second smooth value, and a third smooth value of the first sub-band based on the energy smooth reference value, the scale factor of the first sub-band, and a scale factor of an adjacent sub-band of the first sub-band, where the first sub-band is any sub-band in the first candidate sub-band set; and
determine a scale difference value of the first sub-band based on the first smooth value, the second smooth value, and the third smooth value of the first sub-band.

Optionally, the second determining submodule is configured to:
if the first sub-band is an initial sub-band in the first candidate sub-band set, determine, as the first smooth value of the first sub-band, a larger value in the scale factor of the first sub-band and the energy smooth reference value; or if the first sub-band is not an initial sub-band in the first candidate sub-band set, determine, as the first smooth value of the first sub-band, a larger value in a scale factor of a previous sub-band adjacent to the first sub-band and the energy smooth reference value;
determine, as the second smooth value of the first sub-band, a larger value in the scale factor of the first sub-band and the energy smooth reference value; and
if the first sub-band is a last sub-band in the first candidate sub-band set, determine, as the third smooth value of the first sub-band, a larger value in the scale factor of the first sub-band and the energy smooth reference value; or if the first sub-band is not a last sub-band in the first candidate sub-band set, determine, as the third smooth value of the first sub-band, a larger value in a scale factor of a next sub-band adjacent to the first sub-band and the energy smooth reference value.

Optionally, the second determining submodule is configured to:
for the first sub-band included in the first candidate sub-band set, determine a first difference value and a second difference value of the first sub-band, where the first difference value is an absolute value of a difference value between the first smooth value and the second smooth value of the first sub-band, the second difference value is an absolute value of a difference value between the second smooth value and the third smooth value of the first sub-band, and the first sub-band is any sub-band in the first candidate sub-band set; and
determine the scale difference value of the first sub-band based on the first difference value and the second difference value of the first sub-band.

Optionally, the second determining submodule is configured to:
determine, based on a number of sub-bands included in the first candidate sub-band set and the sub-band bandwidth of each sub-band, a smooth weighting coefficient of each sub-band included in the first candidate sub-band set;
add up smooth the weighting coefficients of the sub-bands included in the first candidate sub-band set, to obtain a total smooth weighting coefficient of the first candidate sub-band set;
multiply the scale difference values of the sub-bands included in the first candidate sub-band set by the smooth weighting coefficients, to obtain weighted scale difference values of the sub-bands included in the first candidate sub-band set;
add up the weighted scale difference values of the sub-bands included in the first candidate sub-band set, to obtain a summation scale value of the first candidate sub-band set; and
divide the summation scale value by the total smooth weighting coefficient of the first candidate sub-band set, to obtain the total scale value of the first candidate sub-band set.

Optionally, the apparatus 1100 further includes:
a bandwidth detection module, configured to: if the encoding bit rate of the audio signal is less than the first bit rate threshold, perform bandwidth detection on a spectrum of the audio signal, to obtain a cut-off frequency of the audio signal; and
a second determining module, configured to determine, based on the cut-off frequency, the cut-off sub-bands respectively corresponding to the plurality of sub-band division manners.

Optionally, the apparatus 1100 further includes:
a third determining module, configured to: if the encoding bit rate of the audio signal is not less than the first bit rate threshold, determine, as a cut-off sub-band corresponding to each sub-band division manner, a last sub-band indicated by each of the plurality of sub-band division manners.

Optionally, the apparatus 1100 further includes:
a feature analysis module, configured to perform feature analysis on the spectrum of the audio signal, to obtain a feature analysis result; and
a fourth determining module, configured to determine the plurality of sub-band division manners from a plurality of candidate sub-band division manners based on the feature analysis result and the encoding bit rate of the audio signal.

Optionally, the feature analysis result includes a subjective signal flag or an objective signal flag, the subjective signal flag indicates that an energy concentration of the audio signal is not greater than a concentration threshold, and the objective signal flag indicates that the energy concentration of the audio signal is greater than the concentration threshold.

Optionally, a frame length of the audio signal is 10 milliseconds, and a sampling rate is 88.2 kilohertz or 96 kilohertz; or a frame length of the audio signal is 5 milliseconds, and a sampling rate is 88.2 kilohertz or 96 kilohertz; or a frame length of the audio signal is 10 milliseconds, and a sampling rate is 44.1 kilohertz or 48 kilohertz.

The fourth determining module includes:

a third determining submodule, configured to: if the encoding bit rate of the audio signal is less than the first bit rate threshold, and the feature analysis result includes the subjective signal flag, determine, as the plurality of sub-band division manners, a first group of sub-band division manners in the plurality of candidate sub-band division manners.

The first group of sub-band division manners are as follows:
{
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 3, 5, 7, 9, 12, 15, 18, 22, 26, 30, 35, 41, 48, 56, 65, 74, 84, 94, 106, 118, 134, 150, 166, 184, 202, 220, 240, 260, 280, 480},
{0, 1, 2, 3, 4, 5, 7, 9, 11, 14, 17, 21, 25, 29, 34, 40, 46, 52, 60, 68, 76, 86, 98, 110, 126, 144, 162, 180, 200, 224, 250, 280, 480},
{0, 2, 4, 6, 8, 12, 16, 21, 26, 31, 36, 41, 46, 51, 56, 61, 66, 71, 77, 83, 89, 95, 103, 111, 121, 131, 147, 163, 179, 203, 240, 280, 480},
{0, 1, 2, 3, 5, 7, 9, 12, 15, 19, 23, 27, 32, 37, 43, 49, 57, 66, 76, 86, 98, 110, 125, 140, 158, 176, 194, 216, 238, 264, 290, 320, 480},
{0, 1, 2, 3, 5, 7, 10, 13, 17, 21, 25, 30, 35, 41, 47, 54, 62, 70, 80, 90, 102, 114, 130, 146, 162, 180, 198, 218, 240, 264, 290, 320, 480},
{0, 1, 2, 4, 6, 8, 11, 14, 18, 22, 26, 30, 36, 42, 50, 58, 66, 76, 88, 100, 112, 128, 144, 160, 182, 204, 226, 256, 286, 316, 352, 400, 480},
{0, 1, 2, 4, 6, 8, 11, 14, 18, 22, 26, 30, 36, 42, 50, 58, 68, 78, 90, 102, 116, 132, 148, 166, 186, 208, 234, 262, 292, 324, 360, 400, 480}
}.

Optionally, a frame length of the audio signal is 10 milliseconds, and a sampling rate is 88.2 kilohertz or 96 kilohertz; or a frame length of the audio signal is 5 milliseconds, and a sampling rate is 88.2 kilohertz or 96 kilohertz; or a frame length of the audio signal is 10 milliseconds, and a sampling rate is 44.1 kilohertz or 48 kilohertz.

The fourth determining module includes:

a fourth determining submodule, configured to: if the encoding bit rate of the audio signal is not less than the first bit rate threshold, and/or the feature analysis result includes the objective signal flag, determine, as the plurality of sub-band division manners, a second group of sub-band division manners in the plurality of candidate sub-band division manners.

The second group of sub-band division manners are as follows:
{
{0, 1, 2, 3, 4, 5, 6, 7, 8, 10, 12, 14, 16, 19, 22, 26, 30, 35, 40, 45, 50, 57, 64, 73, 82, 92, 102, 112, 124, 136, 148, 160, 480},
{0, 1, 2, 3, 4, 5, 7, 9, 11, 13, 15, 18, 21, 24, 28, 33, 38, 44, 50, 57, 64, 73, 82, 93, 104, 116, 128, 140, 155, 170, 185, 200, 480},
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 4, 6, 10, 14, 18, 22, 26, 30, 34, 42, 50, 58, 66, 74, 84, 96, 108, 120, 136, 152, 168, 192, 216, 240, 272, 304, 336, 376, 424, 480},
{0, 1, 2, 4, 6, 10, 14, 18, 26, 34, 42, 50, 62, 74, 86, 98, 112, 128, 144, 160, 176, 196, 216, 236, 256, 280, 304, 328, 352, 384, 416, 448, 480},
{0, 80, 92, 104, 112, 120, 128, 136, 144, 148, 152, 156, 160, 164, 168, 172, 176, 180, 184, 188, 192, 196, 200, 208, 216, 224, 232, 240, 248, 256, 268, 280, 480},
{0, 200, 212, 224, 232, 240, 248, 256, 264, 268, 272, 276, 280, 284, 288, 292, 296, 300, 304, 308, 312, 316, 320, 328, 336, 344, 352, 360, 368, 376, 388, 400, 480},
{0, 320, 332, 344, 356, 364, 372, 380, 384, 388, 392, 396, 400, 404, 408, 412, 416, 420, 424, 428, 432, 436, 440, 444, 448, 452, 456, 460, 464, 468, 472, 476, 480}
}.

Optionally, a frame length of the audio signal is 5 milliseconds, and a sampling rate is 44.1 kilohertz or 48 kilohertz.

The fourth determining module includes:
a fifth determining submodule, configured to: if the encoding bit rate of the audio signal is less than the first bit rate threshold, and the feature analysis result includes the subjective signal flag, determine, as the plurality of sub-band division manners, a third group of sub-band division manners in the plurality of candidate sub-band division manners.

The third group of sub-band division manners are as follows:
{
{0, 1, 2, 3, 4, 5, 6, 7, 8, 9, 10, 12, 14, 16, 19, 22, 26, 30, 35, 39, 44, 50, 56, 63, 71, 80, 89, 98, 108, 119, 129, 140, 240},
{0, 1, 2, 3, 4, 5, 6, 7, 8, 9, 11, 13, 15, 17, 20, 24, 28, 32, 37, 42, 47, 53, 59, 67, 75, 83, 92, 101, 110, 120, 130, 140, 240},
{0, 1, 2, 3, 4, 5, 6, 7, 8, 9, 10, 11, 12, 14, 17, 20, 23, 26, 30, 34, 38, 43, 49, 55, 63, 72, 81, 90, 100, 112, 125, 140, 240},
{0, 1, 2, 3, 4, 6, 8, 10, 13, 15, 18, 20, 23, 25, 28, 30, 33, 35, 38, 41, 44, 47, 51, 55, 60, 65, 73, 81, 89, 101, 120, 140, 240},
{0, 1, 2, 3, 4, 5, 6, 7, 9, 11, 13, 14, 16, 18, 21, 24, 28, 33, 38, 43, 49, 55, 62, 70, 79, 88, 97, 108, 119, 132, 145, 160, 240},
{0, 1, 2, 3, 4, 5, 6, 7, 8, 10, 12, 14, 17, 20, 23, 27, 31, 35, 40, 45, 51, 57, 65, 73, 81, 90, 99, 109, 120, 132, 145, 160, 240},
{0, 1, 2, 3, 4, 5, 6, 7, 9, 11, 13, 15, 18, 21, 25, 29, 33, 38, 44, 50, 56, 64, 72, 80, 91, 102, 113, 128, 143, 158, 176, 200, 240},
{0, 1, 2, 3, 4, 5, 6, 7, 9, 11, 13, 15, 18, 21, 25, 29, 34, 39, 45, 51, 58, 66, 74, 83, 93, 104, 117, 131, 146, 162, 180, 200, 240}
}.

Optionally, a frame length of the audio signal is 5 milliseconds, and a sampling rate is 44.1 kilohertz or 48 kilohertz.

The fourth determining module includes:
a sixth determining submodule, configured to: if the encoding bit rate of the audio signal is not less than the first bit rate threshold, and/or the feature analysis result includes the objective signal flag, determine, as the plurality of sub-band division manners, a fourth group of sub-band division manners in the plurality of candidate sub-band division manners.

The fourth group of sub-band division manners are as follows:
{
{0, 1, 2, 3, 4, 5, 6, 7, 8, 9, 10, 11, 12, 13, 14, 15, 16, 17, 18, 19, 20, 21, 22, 23, 24, 26, 28, 30, 32, 34, 37, 40, 120},
{0, 1, 2, 3, 4, 5, 6, 7, 8, 9, 10, 11, 12, 13, 14, 15, 16, 18, 20, 22, 24, 26, 28, 30, 32, 34, 36, 38, 41, 44, 47, 50, 120},
{0, 1, 2, 3, 4, 5, 6, 7, 8, 9, 10, 11, 12, 14, 16, 18, 20, 22, 24, 26, 28, 31, 34, 37, 40, 44, 48, 52, 56, 60, 65, 70, 120},
{0, 1, 2, 3, 4, 5, 6, 7, 8, 9, 10, 11, 12, 13, 15, 17, 19, 21, 24, 27, 30, 34, 38, 42, 48, 54, 60, 68, 76, 84, 94, 106, 120},
{0, 1, 2, 3, 4, 5, 6, 7, 8, 10, 12, 14, 16, 19, 22, 25, 28, 32, 36, 40, 44, 49, 54, 59, 64, 70, 76, 82, 88, 96, 104, 112, 120},
{0, 20, 23, 26, 28, 30, 32, 34, 36, 37, 38, 39, 40, 41, 42, 43, 44, 45, 46, 47, 48, 49, 50, 52, 54, 56, 58, 60, 62, 64, 67, 70, 120},
{0, 50, 53, 56, 58, 60, 62, 64, 66, 67, 68, 69, 70, 71, 72, 73, 74, 75, 76, 77, 78, 79, 80, 82, 84, 86, 88, 90, 92, 94, 97, 100, 120},
{0, 80, 83, 86, 89, 91, 93, 95, 96, 97, 98, 99, 100, 101, 102, 103, 104, 105, 106, 107, 108, 109, 110, 111, 112, 113, 114, 115, 116, 117, 118, 119, 120}
}.

Optionally, the audio signal is a dual-channel signal.

The apparatus 1100 further includes:
a fifth determining module, configured to determine a first total scale value based on the scale factor and a sub-band bandwidth of each sub-band included in the target sub-band set;
a transform module, configured to perform mid/side-stereo transform coding on the spectrum of the dual-channel signal, to obtain a transformed spectrum of the dual-channel signal;
a sixth determining module, configured to determine a transformed scale factor of each sub-band in the target sub-band set based on the transformed spectral value of the dual-channel signal in each sub-band included in the target sub-band set;
a seventh determining module, configured to determine a second total scale value based on the transformed scale factor and the sub-band bandwidth of each sub-band included in the target sub-band set; and
an eighth determining module, configured to: if the first total scale value is not greater than the second total scale value, determine the dual-channel signal as a to-be-encoded signal.

Optionally, the apparatus 1100 is further configured to:
if the first total scale value is greater than the second total scale value, and the encoding bit rate of the audio signal is not less than the first bit rate threshold, and/or the energy concentration of the audio signal is greater than the concentration threshold, determine the transformed dual-channel signal as a to-be-encoded signal.

Optionally, the scale factor includes a left-channel scale factor and a right-channel scale factor.

The apparatus 1100 further includes:
a ninth determining module, configured to: if the first total scale value is greater than the second total scale value, the encoding bit rate of the audio signal is less than the first bit rate threshold, and the energy concentration of the audio signal is not greater than the concentration threshold, determine, based on a left-channel scale factor and a right-channel scale factor of each sub-band included in the target sub-band set, a difference value between the left channel scale factor and the right channel scale factor of each sub-band included in the target sub-band set;
a tenth determining module, configured to determine, based on an initial frequency and a cut-off frequency of each sub-band included in the target sub-band set, a sub-band center frequency of each sub-band included in the target sub-band set; and
an eleventh determining module, configured to: if there is at least one sub-band, in the target sub-band set, that has a difference value between a left channel scale factor and a right channel scale factor greater than a difference threshold and whose sub-band center frequency is within a first range, determine the dual-channel signal as a to-be-encoded signal.

Optionally, the apparatus 1100 is further configured to:
if the at least one sub-band does not exist in the target sub-band set, determine the transformed dual-channel signal as a to-be-encoded signal.

In embodiments of this application, an optimal sub-band division manner is selected from the plurality of sub-band division manners based on a characteristic of the audio signal. In other words, the sub-band division manner has a signal adaptation characteristic, and can adapt to the encoding bit rate of the audio signal, to improve an anti-interference capability. Specifically, the audio signal is divided separately based on the plurality of sub-band division manners, the total scale value corresponding to each sub-band division manner is determined based on spectral values of the audio signal in sub-bands obtained through division, the bandwidth of each sub-band, and the encoding bit rate of the audio signal, and the optimal target sub-band division manner is selected based on the total scale value, to obtain the optimal sub-band set. Subsequently, spectral envelope shaping is performed based on the scale factor of each sub-band in the optimal sub-band set, to improve coding effect and compression efficiency.

It should be noted that when the audio signal processing apparatus provided in the foregoing embodiment processes the audio signal, division of the foregoing functional modules is merely used as an example for description. During actual application, the foregoing functions may be allocated to different functional modules for implementation based on a requirement. In other words, an internal structure of the apparatus is divided into different functional modules to implement all or some of the functions described above. In addition, the audio signal processing apparatus provided in the foregoing embodiment and the audio signal processing method embodiments belong to a same concept. For specific implementation processes thereof, refer to the method embodiments. Details are not described herein again.

All or some of the foregoing embodiments may be implemented by software, hardware, firmware, or any combination thereof. When software is used for implementation, all or some of embodiments may be implemented in a form of a computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium, or may be transmitted from a computer-readable storage medium to another computer-readable storage medium. For example, the computer instructions may be transmitted from a website, a computer, a server, or a data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a digital versatile disc (digital versatile disc, DVD)), a semiconductor medium (for example, a solid-state disk (solid-state disk, SSD)), or the like. It should be noted that the computer-readable storage medium mentioned in embodiments of this application may be a non-volatile storage medium, that is, may be a non-transitory storage medium.

It should be understood that “at least one” mentioned in this specification indicates one or more, and “a plurality of” indicates two or more. In the descriptions of embodiments of this application, unless otherwise specified, “/” means “or”. For example, A/B may represent A or B. In this specification, “and/or” describes only an association relationship between associated objects and represents that three relationships may exist. For example, A and/or B may represent the following three cases: Only A exists, both A and B exist, and only B exists. In addition, to clearly describe the technical solutions in embodiments of this application, terms such as “first” and “second” are used in embodiments of this application to distinguish between same items or similar items that have basically same functions and purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of this application are used under authorization by the user or full authorization by all parties, and capturing, use, and processing of related data need to conform to related laws, regulations, and standards of related countries and regions. For example, the audio signal related in embodiments of this application is obtained under full authorization.

The foregoing descriptions are embodiments provided in this application, but are not intended to limit this application. Any modification, equivalent replacement, or improvement made without departing from the principle of this application shall fall within the protection scope of this application.

What is claimed is:

1. An audio signal processing method, comprising:
separately performing sub-band division on an audio signal based on a plurality of sub-band division manners and cut-off sub-bands corresponding to the plurality of sub-band division manners, to obtain a plurality of candidate sub-band sets, wherein the plurality of candidate sub-band sets correspond to the plurality of sub-band division manners, and each candidate sub-band set comprises a plurality of sub-bands;
determining a total scale value of each candidate sub-band set based on spectral values of the audio signal in the sub-bands comprised in the candidate sub-band set, an encoding bit rate of the audio signal, and sub-band bandwidths of the sub-bands comprised in the candidate sub-band set; and
selecting, as a target sub-band set, one candidate sub-band set from the plurality of candidate sub-band sets based on the total scale value of each candidate sub-band set, wherein each sub-band comprised in the target sub-band set has a scale factor, and the scale factor is used to shape a spectral envelope of the audio signal.

2. The method according to claim 1, wherein the selecting, as a target sub-band set, one candidate sub-band set from the plurality of candidate sub-band sets based on the total scale value of each candidate sub-band set comprises:
determining, as the target sub-band set, a candidate sub-band set with a smallest total scale value in the plurality of candidate sub-band sets.

3. The method according to claim 2, wherein the determining a total scale value of each candidate sub-band set based on spectral values of the audio signal in the sub-bands comprised in the candidate sub-band set, an encoding bit rate of the audio signal, and sub-band bandwidths of the sub-bands comprised in the candidate sub-band set comprises:
determining, for a first candidate sub-band set in the plurality of candidate sub-band sets, based on spectral values of the audio signal in sub-bands comprised in the first candidate sub-band set, a scale factor of each sub-band comprised in the first candidate sub-band set, wherein the first candidate sub-band set is any one of the plurality of candidate sub-band sets; and
determining a total scale value of the first candidate sub-band set based on the encoding bit rate of the audio signal, and the scale factor and a sub-band bandwidth of each sub-band comprised in the first candidate sub-band set.

4. The method according to claim 3, wherein the determining, based on spectral values of the audio signal in sub-bands comprised in the first candidate sub-band set, a scale factor of each sub-band comprised in the first candidate sub-band set comprises:
obtaining, for a first sub-band comprised in the first candidate sub-band set, a maximum value in absolute values of all spectral values of the audio signal in the first sub-band, wherein the first sub-band is any sub-band in the first candidate sub-band set; and
determining a scale factor of the first sub-band based on the maximum value.

5. The method according to claim 3, wherein at least one of the encoding bit rate of the audio signal is not less than a first bit rate threshold, and an energy concentration of the audio signal is greater than a concentration threshold; and
the determining a total scale value of the first candidate sub-band set based on the encoding bit rate of the audio signal, and the scale factor and a sub-band bandwidth of each sub-band comprised in the first candidate sub-band set comprises:
determining an energy smooth reference value based on the encoding bit rate of the audio signal and a second bit rate threshold;
determining, based on the energy smooth reference value, and the scale factor and the sub-band bandwidth of each sub-band comprised in the first candidate sub-band set, a total energy value of each sub-band comprised in the first candidate sub-band set; and
adding up the total energy values of the sub-bands comprised in the first candidate sub-band set, to obtain the total scale value of the first candidate sub-band set.

6. The method according to claim 5, wherein the determining, based on the energy smooth reference value, and the scale factor and the sub-band bandwidth of each sub-band comprised in the first candidate sub-band set, a total energy value of each sub-band comprised in the first candidate sub-band set comprises:
determining, for the first sub-band comprised in the first candidate sub-band set, as a reference scale value of the first sub-band, a larger value in the scale factor of the first sub-band and the energy smooth reference value, wherein the first sub-band is any sub-band in the first candidate sub-band set; and
determining, as a total energy value of the first sub-band, a product of the reference scale value of the first sub-band and a sub-band bandwidth of the first sub-band.

7. The method according to claim 1, wherein the method further comprises:
performing feature analysis on the spectrum of the audio signal, to obtain a feature analysis result; and
determining the plurality of sub-band division manners from a plurality of candidate sub-band division manners based on the feature analysis result and the encoding bit rate of the audio signal.

8. The method according to claim 7, wherein one of a frame length of the audio signal is 10 milliseconds, and a sampling rate is one of 88.2 kilohertz or 96 kilohertz; or a frame length of the audio signal is 5 milliseconds, and a sampling rate is one of 88.2 kilohertz or 96 kilohertz; or a frame length of the audio signal is 10 milliseconds, and a sampling rate is one of 44.1 kilohertz or 48 kilohertz; and
a first group of sub-band division manners are as follows:
{
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 3, 5, 7, 9, 12, 15, 18, 22, 26, 30, 35, 41, 48, 56, 65, 74, 84, 94, 106, 118, 134, 150, 166, 184, 202, 220, 240, 260, 280, 480},
{0, 1, 2, 3, 4, 5, 7, 9, 11, 14, 17, 21, 25, 29, 34, 40, 46, 52, 60, 68, 76, 86, 98, 110, 126, 144, 162, 180, 200, 224, 250, 280, 480},
{0, 2, 4, 6, 8, 12, 16, 21, 26, 31, 36, 41, 46, 51, 56, 61, 66, 71, 77, 83, 89, 95, 103, 111, 121, 131, 147, 163, 179, 203, 240, 280, 480},
{0, 1, 2, 3, 5, 7, 9, 12, 15, 19, 23, 27, 32, 37, 43, 49, 57, 66, 76, 86, 98, 110, 125, 140, 158, 176, 194, 216, 238, 264, 290, 320, 480},
{0, 1, 2, 3, 5, 7, 10, 13, 17, 21, 25, 30, 35, 41, 47, 54, 62, 70, 80, 90, 102, 114, 130, 146, 162, 180, 198, 218, 240, 264, 290, 320, 480},
{0, 1, 2, 4, 6, 8, 11, 14, 18, 22, 26, 30, 36, 42, 50, 58, 66, 76, 88, 100, 112, 128, 144, 160, 182, 204, 226, 256, 286, 316, 352, 400, 480},
{0, 1, 2, 4, 6, 8, 11, 14, 18, 22, 26, 30, 36, 42, 50, 58, 68, 78, 90, 102, 116, 132, 148, 166, 186, 208, 234, 262, 292, 324, 360, 400, 480}
}.

9. The method according to claim 7, wherein a frame length of the audio signal is 10 milliseconds, and a sampling rate is 88.2 kilohertz or 96 kilohertz; or a frame length of the audio signal is 5 milliseconds, and a sampling rate is 88.2 kilohertz or 96 kilohertz; or a frame length of the audio signal is 10 milliseconds, and a sampling rate is one of 44.1 kilohertz or 48 kilohertz; and
a second group of sub-band division manners are as follows:
{
{0, 1, 2, 3, 4, 5, 6, 7, 8, 10, 12, 14, 16, 19, 22, 26, 30, 35, 40, 45, 50, 57, 64, 73, 82, 92, 102, 112, 124, 136, 148, 160, 480},
{0, 1, 2, 3, 4, 5, 7, 9, 11, 13, 15, 18, 21, 24, 28, 33, 38, 44, 50, 57, 64, 73, 82, 93, 104, 116, 128, 140, 155, 170, 185, 200, 480},
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 4, 6, 10, 14, 18, 22, 26, 30, 34, 42, 50, 58, 66, 74, 84, 96, 108, 120, 136, 152, 168, 192, 216, 240, 272, 304, 336, 376, 424, 480},
{0, 1, 2, 4, 6, 10, 14, 18, 26, 34, 42, 50, 62, 74, 86, 98, 112, 128, 144, 160, 176, 196, 216, 236, 256, 280, 304, 328, 352, 384, 416, 448, 480},
{0, 80, 92, 104, 112, 120, 128, 136, 144, 148, 152, 156, 160, 164, 168, 172, 176, 180, 184, 188, 192, 196, 200, 208, 216, 224, 232, 240, 248, 256, 268, 280, 480},
{0, 200, 212, 224, 232, 240, 248, 256, 264, 268, 272, 276, 280, 284, 288, 292, 296, 300, 304, 308, 312, 316, 320, 328, 336, 344, 352, 360, 368, 376, 388, 400, 480},
{0, 320, 332, 344, 356, 364, 372, 380, 384, 388, 392, 396, 400, 404, 408, 412, 416, 420, 424, 428, 432, 436, 440, 444, 448, 452, 456, 460, 464, 468, 472, 476, 480}
}.

10. The method according to claim 7, wherein a frame length of the audio signal is 5 milliseconds, and a sampling rate is one of 44.1 kilohertz or 48 kilohertz; wherein a third group of sub-band division manners are as follows:
{
{0, 1, 2, 3, 4, 5, 6, 7, 8, 9, 10, 12, 14, 16, 19, 22, 26, 30, 35, 39, 44, 50, 56, 63, 71, 80, 89, 98, 108, 119, 129, 140, 240},
{0, 1, 2, 3, 4, 5, 6, 7, 8, 9, 11, 13, 15, 17, 20, 24, 28, 32, 37, 42, 47, 53, 59, 67, 75, 83, 92, 101, 110, 120, 130, 140, 240},
{0, 1, 2, 3, 4, 5, 6, 7, 8, 9, 10, 11, 12, 14, 17, 20, 23, 26, 30, 34, 38, 43, 49, 55, 63, 72, 81, 90, 100, 112, 125, 140, 240},
{0, 1, 2, 3, 4, 6, 8, 10, 13, 15, 18, 20, 23, 25, 28, 30, 33, 35, 38, 41, 44, 47, 51, 55, 60, 65, 73, 81, 89, 101, 120, 140, 240},
{0, 1, 2, 3, 4, 5, 6, 7, 9, 11, 13, 14, 16, 18, 21, 24, 28, 33, 38, 43, 49, 55, 62, 70, 79, 88, 97, 108, 119, 132, 145, 160, 240},
{0, 1, 2, 3, 4, 5, 6, 7, 8, 10, 12, 14, 17, 20, 23, 27, 31, 35, 40, 45, 51, 57, 65, 73, 81, 90, 99, 109, 120, 132, 145, 160, 240},
{0, 1, 2, 3, 4, 5, 6, 7, 9, 11, 13, 15, 18, 21, 25, 29, 33, 38, 44, 50, 56, 64, 72, 80, 91, 102, 113, 128, 143, 158, 176, 200, 240},
{0, 1, 2, 3, 4, 5, 6, 7, 9, 11, 13, 15, 18, 21, 25, 29, 34, 39, 45, 51, 58, 66, 74, 83, 93, 104, 117, 131, 146, 162, 180, 200, 240}
}.

11. An audio signal processing method, comprising:
decoding a bitstream to obtain side information, wherein the side information comprises information about a target sub-band division manner, a quantization step, and scale factors of each sub-bands in a target sub-band set, the target sub-band division manner indicates a sub-band division manner of an audio signal in the bitstream, the target sub-band set is obtained by dividing the audio signal according to the target sub-band division manner;
decoding spectrum data of each sub-band in the target sub-band set based on the information about the target sub-band division manner, the quantization step, and the scale factors of each sub-bands in the target sub-band set.

12. The method according to claim 11, further comprising:
after decoding spectrum data of each sub-band in the target sub-band set, when a bit is still remaining in the bitstream, performing residual decoding on the bitstream, to obtain spectrum data of another sub-band.

13. The method according to claim 12, wherein the side information further comprises a low bit rate flag, wherein:
before the decoding spectrum data of each sub-band in the target sub-band set, the method further comprises:
performing spectral noise shaping based on the scale factors to obtain adjustment factors, when the low bit rate flag indicates a low bit rate of the bitstream, the adjustment factors are used to dequantize decoded spectral data.

14. The method according to claim 11, wherein one of a frame length of the audio signal is 10 milliseconds, and a sampling rate is one of 88.2 kilohertz or 96 kilohertz; or a frame length of the audio signal is 5 milliseconds, and a sampling rate is one of 88.2 kilohertz or 96 kilohertz; or a frame length of the audio signal is 10 milliseconds, and a sampling rate is one of 44.1 kilohertz or 48 kilohertz;
the target sub-band division manner belongs to a first group of sub-band division manners as follows:
{
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 3, 5, 7, 9, 12, 15, 18, 22, 26, 30, 35, 41, 48, 56, 65, 74, 84, 94, 106, 118, 134, 150, 166, 184, 202, 220, 240, 260, 280, 480},
{0, 1, 2, 3, 4, 5, 7, 9, 11, 14, 17, 21, 25, 29, 34, 40, 46, 52, 60, 68, 76, 86, 98, 110, 126, 144, 162, 180, 200, 224, 250, 280, 480},
{0, 2, 4, 6, 8, 12, 16, 21, 26, 31, 36, 41, 46, 51, 56, 61, 66, 71, 77, 83, 89, 95, 103, 111, 121, 131, 147, 163, 179, 203, 240, 280, 480},
{0, 1, 2, 3, 5, 7, 9, 12, 15, 19, 23, 27, 32, 37, 43, 49, 57, 66, 76, 86, 98, 110, 125, 140, 158, 176, 194, 216, 238, 264, 290, 320, 480},
{0, 1, 2, 3, 5, 7, 10, 13, 17, 21, 25, 30, 35, 41, 47, 54, 62, 70, 80, 90, 102, 114, 130, 146, 162, 180, 198, 218, 240, 264, 290, 320, 480},
{0, 1, 2, 4, 6, 8, 11, 14, 18, 22, 26, 30, 36, 42, 50, 58, 66, 76, 88, 100, 112, 128, 144, 160, 182, 204, 226, 256, 286, 316, 352, 400, 480},
{0, 1, 2, 4, 6, 8, 11, 14, 18, 22, 26, 30, 36, 42, 50, 58, 68, 78, 90, 102, 116, 132, 148, 166, 186, 208, 234, 262, 292, 324, 360, 400, 480}
}; or
the target sub-band division manner belongs to a second group of sub-band division manners as follows:
{
{0, 1, 2, 3, 4, 5, 6, 7, 8, 10, 12, 14, 16, 19, 22, 26, 30, 35, 40, 45, 50, 57, 64, 73, 82, 92, 102, 112, 124, 136, 148, 160, 480},
{0, 1, 2, 3, 4, 5, 7, 9, 11, 13, 15, 18, 21, 24, 28, 33, 38, 44, 50, 57, 64, 73, 82, 93, 104, 116, 128, 140, 155, 170, 185, 200, 480},
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 4, 6, 10, 14, 18, 22, 26, 30, 34, 42, 50, 58, 66, 74, 84, 96, 108, 120, 136, 152, 168, 192, 216, 240, 272, 304, 336, 376, 424, 480},
{0, 1, 2, 4, 6, 10, 14, 18, 26, 34, 42, 50, 62, 74, 86, 98, 112, 128, 144, 160, 176, 196, 216, 236, 256, 280, 304, 328, 352, 384, 416, 448, 480},
{0, 80, 92, 104, 112, 120, 128, 136, 144, 148, 152, 156, 160, 164, 168, 172, 176, 180, 184, 188, 192, 196, 200, 208, 216, 224, 232, 240, 248, 256, 268, 280, 480},
{0, 200, 212, 224, 232, 240, 248, 256, 264, 268, 272, 276, 280, 284, 288, 292, 296, 300, 304, 308, 312, 316, 320, 328, 336, 344, 352, 360, 368, 376, 388, 400, 480},
{0, 320, 332, 344, 356, 364, 372, 380, 384, 388, 392, 396, 400, 404, 408, 412, 416, 420, 424, 428, 432, 436, 440, 444, 448, 452, 456, 460, 464, 468, 472, 476, 480}
}.

15. The method according to claim 11, wherein a frame length of the audio signal is 5 milliseconds, and a sampling rate is one of 44.1 kilohertz or 48 kilohertz, and the target sub-band division manner belongs to a third group of sub-band division manners as follows:
{
{0, 1, 2, 3, 4, 5, 6, 7, 8, 9, 10, 12, 14, 16, 19, 22, 26, 30, 35, 39, 44, 50, 56, 63, 71, 80, 89, 98, 108, 119, 129, 140, 240},
{0, 1, 2, 3, 4, 5, 6, 7, 8, 9, 11, 13, 15, 17, 20, 24, 28, 32, 37, 42, 47, 53, 59, 67, 75, 83, 92, 101, 110, 120, 130, 140, 240},
{0, 1, 2, 3, 4, 5, 6, 7, 8, 9, 10, 11, 12, 14, 17, 20, 23, 26, 30, 34, 38, 43, 49, 55, 63, 72, 81, 90, 100, 112, 125, 140, 240},
{0, 1, 2, 3, 4, 6, 8, 10, 13, 15, 18, 20, 23, 25, 28, 30, 33, 35, 38, 41, 44, 47, 51, 55, 60, 65, 73, 81, 89, 101, 120, 140, 240},
{0, 1, 2, 3, 4, 5, 6, 7, 9, 11, 13, 14, 16, 18, 21, 24, 28, 33, 38, 43, 49, 55, 62, 70, 79, 88, 97, 108, 119, 132, 145, 160, 240},
{0, 1, 2, 3, 4, 5, 6, 7, 8, 10, 12, 14, 17, 20, 23, 27, 31, 35, 40, 45, 51, 57, 65, 73, 81, 90, 99, 109, 120, 132, 145, 160, 240},
{0, 1, 2, 3, 4, 5, 6, 7, 9, 11, 13, 15, 18, 21, 25, 29, 33, 38, 44, 50, 56, 64, 72, 80, 91, 102, 113, 128, 143, 158, 176, 200, 240},
{0, 1, 2, 3, 4, 5, 6, 7, 9, 11, 13, 15, 18, 21, 25, 29, 34, 39, 45, 51, 58, 66, 74, 83, 93, 104, 117, 131, 146, 162, 180, 200, 240}
}.

16. An audio signal processing device, wherein the device comprises a memory and a processor;
the memory is configured to store a computer program, wherein the computer program comprises program instructions; and
the processor is configured to invoke the computer program to:
decode a bitstream to obtain side information, wherein the side information comprises information about a target sub-band division manner, a quantization step, and scale factors of each sub-bands in a target sub-band set, the target sub-band division manner indicates a sub-band division manner of an audio signal in the bitstream, the target sub-band set is obtained by dividing the audio signal according to the target sub-band division manner;
decode spectrum data of each sub-band in the target sub-band set based on the information about the target sub-band division manner, the quantization step, and the scale factors of each sub-bands in the target sub-band set.

17. The device according to claim 16, wherein the processor is further configured to invoke the computer program to:
after decoding spectrum data of each sub-band in the target sub-band set, when a bit is still remaining in the bitstream, perform residual decoding on the bitstream, to obtain spectrum data of another sub-band.

18. The device according to claim 17, wherein the side information further comprises a low bit rate flag, wherein the processor is further configured to invoke the computer program to:
before the decoding spectrum data of each sub-band in the target sub-band set, perform spectral noise shaping based on the scale factors to obtain adjustment factors, when the low bit rate flag indicates a low bit rate of the bitstream, the adjustment factors are used to dequantize decoded spectral data.

19. The device according to claim 16, wherein one of a frame length of the audio signal is 10 milliseconds, and a sampling rate is one of 88.2 kilohertz or 96 kilohertz; or a frame length of the audio signal is 5 milliseconds, and a sampling rate is one of 88.2 kilohertz or 96 kilohertz; or a frame length of the audio signal is 10 milliseconds, and a sampling rate is one of 44.1 kilohertz or 48 kilohertz;
the target sub-band division manner belongs to a first group of sub-band division manners as follows:
{
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 3, 5, 7, 9, 12, 15, 18, 22, 26, 30, 35, 41, 48, 56, 65, 74, 84, 94, 106, 118, 134, 150, 166, 184, 202, 220, 240, 260, 280, 480},
{0, 1, 2, 3, 4, 5, 7, 9, 11, 14, 17, 21, 25, 29, 34, 40, 46, 52, 60, 68, 76, 86, 98, 110, 126, 144, 162, 180, 200, 224, 250, 280, 480},
{0, 2, 4, 6, 8, 12, 16, 21, 26, 31, 36, 41, 46, 51, 56, 61, 66, 71, 77, 83, 89, 95, 103, 111, 121, 131, 147, 163, 179, 203, 240, 280, 480},
{0, 1, 2, 3, 5, 7, 9, 12, 15, 19, 23, 27, 32, 37, 43, 49, 57, 66, 76, 86, 98, 110, 125, 140, 158, 176, 194, 216, 238, 264, 290, 320, 480},
{0, 1, 2, 3, 5, 7, 10, 13, 17, 21, 25, 30, 35, 41, 47, 54, 62, 70, 80, 90, 102, 114, 130, 146, 162, 180, 198, 218, 240, 264, 290, 320, 480},
{0, 1, 2, 4, 6, 8, 11, 14, 18, 22, 26, 30, 36, 42, 50, 58, 66, 76, 88, 100, 112, 128, 144, 160, 182, 204, 226, 256, 286, 316, 352, 400, 480},
{0, 1, 2, 4, 6, 8, 11, 14, 18, 22, 26, 30, 36, 42, 50, 58, 68, 78, 90, 102, 116, 132, 148, 166, 186, 208, 234, 262, 292, 324, 360, 400, 480}
}; or
the target sub-band division manner belongs to a second group of sub-band division manners as follows:
{
{0, 1, 2, 3, 4, 5, 6, 7, 8, 10, 12, 14, 16, 19, 22, 26, 30, 35, 40, 45, 50, 57, 64, 73, 82, 92, 102, 112, 124, 136, 148, 160, 480},
{0, 1, 2, 3, 4, 5, 7, 9, 11, 13, 15, 18, 21, 24, 28, 33, 38, 44, 50, 57, 64, 73, 82, 93, 104, 116, 128, 140, 155, 170, 185, 200, 480},
{0, 1, 2, 3, 4, 6, 8, 10, 13, 16, 20, 24, 28, 33, 38, 45, 52, 61, 70, 79, 88, 100, 112, 127, 142, 160, 178, 196, 217, 238, 259, 280, 480},
{0, 1, 2, 4, 6, 10, 14, 18, 22, 26, 30, 34, 42, 50, 58, 66, 74, 84, 96, 108, 120, 136, 152, 168, 192, 216, 240, 272, 304, 336, 376, 424, 480},
{0, 1, 2, 4, 6, 10, 14, 18, 26, 34, 42, 50, 62, 74, 86, 98, 112, 128, 144, 160, 176, 196, 216, 236, 256, 280, 304, 328, 352, 384, 416, 448, 480},
{0, 80, 92, 104, 112, 120, 128, 136, 144, 148, 152, 156, 160, 164, 168, 172, 176, 180, 184, 188, 192, 196, 200, 208, 216, 224, 232, 240, 248, 256, 268, 280, 480},
{0, 200, 212, 224, 232, 240, 248, 256, 264, 268, 272, 276, 280, 284, 288, 292, 296, 300, 304, 308, 312, 316, 320, 328, 336, 344, 352, 360, 368, 376, 388, 400, 480},
{0, 320, 332, 344, 356, 364, 372, 380, 384, 388, 392, 396, 400, 404, 408, 412, 416, 420, 424, 428, 432, 436, 440, 444, 448, 452, 456, 460, 464, 468, 472, 476, 480}
}.

20. The device according to claim 16, wherein a frame length of the audio signal is 5 milliseconds, and a sampling rate is one of 44.1 kilohertz or 48 kilohertz, and the target sub-band division manner belongs to a third group of sub-band division manners as follows:
{
{0, 1, 2, 3, 4, 5, 6, 7, 8, 9, 10, 12, 14, 16, 19, 22, 26, 30, 35, 39, 44, 50, 56, 63, 71, 80, 89, 98, 108, 119, 129, 140, 240},
{0, 1, 2, 3, 4, 5, 6, 7, 8, 9, 11, 13, 15, 17, 20, 24, 28, 32, 37, 42, 47, 53, 59, 67, 75, 83, 92, 101, 110, 120, 130, 140, 240},
{0, 1, 2, 3, 4, 5, 6, 7, 8, 9, 10, 11, 12, 14, 17, 20, 23, 26, 30, 34, 38, 43, 49, 55, 63, 72, 81, 90, 100, 112, 125, 140, 240},
{0, 1, 2, 3, 4, 6, 8, 10, 13, 15, 18, 20, 23, 25, 28, 30, 33, 35, 38, 41, 44, 47, 51, 55, 60, 65, 73, 81, 89, 101, 120, 140, 240},
{0, 1, 2, 3, 4, 5, 6, 7, 9, 11, 13, 14, 16, 18, 21, 24, 28, 33, 38, 43, 49, 55, 62, 70, 79, 88, 97, 108, 119, 132, 145, 160, 240},
{0, 1, 2, 3, 4, 5, 6, 7, 8, 10, 12, 14, 17, 20, 23, 27, 31, 35, 40, 45, 51, 57, 65, 73, 81, 90, 99, 109, 120, 132, 145, 160, 240},
{0, 1, 2, 3, 4, 5, 6, 7, 9, 11, 13, 15, 18, 21, 25, 29, 33, 38, 44, 50, 56, 64, 72, 80, 91, 102, 113, 128, 143, 158, 176, 200, 240},
{0, 1, 2, 3, 4, 5, 6, 7, 9, 11, 13, 15, 18, 21, 25, 29, 34, 39, 45, 51, 58, 66, 74, 83, 93, 104, 117, 131, 146, 162, 180, 200, 240}
}.
